(19) United States
(12) Patent Application Publication
(10) Pub. No.: US 2016/0379490 A1
(43) Pub. Date: Dec. 29, 2016

(54) TRAFFIC CONTROL SYSTEM AND METHOD OF USE

(71) Applicant: Haws Corporation, Sparks, NV (US)

(72) Inventors: Andreas Simanowski, Reno, NV (US); Ryan Oddo, Sparks, NV (US); Jordon Tolotti, Sparks, NV (US); Lawrence Miller, Scotts Valley, CA (US); Kevin Stichter, San Francisco, CA (US)

(73) Assignee: Haws Corporation, Sparks, NV (US)

(21) Appl. No.: 15/258,013

(22) Filed: Sep. 7, 2016

Related U.S. Application Data
(63) Continuation of application No. 14/683,102, filed on Apr. 9, 2015, now abandoned.
(60) Provisional application No. 61/977,530, filed on Apr. 9, 2014.
(60) Provisional application No. 62/034,039, filed on Aug. 6, 2014.
(60) Provisional application No. 62/178,426, filed on Apr. 9, 2015.

(51) Int. Cl. G08G 1/081; G08G 1/095; G08G 1/015

(52) U.S. Cl. CPC G08G 1/081; G08G 1/015; G08G 1/095

(57) ABSTRACT

An automated traffic control process and system providing automatic remote monitoring the locations of one or more remote vehicles, determining which vehicles fall within one or more preference categories, and if a vehicle in a particular preference category is detected as approaching a remote intersection, issuing a preemption instruction to a traffic signal controller for the remote intersection. Various other process and system features can include one or more among: monitoring numerous vehicles and intersections, vehicle location monitoring, categorization, and issuance of preemption instructions on a centralized computing system; safety or other condition assessment and control of issuance of signaling instructions accordingly; determination of whether one or more the traffic intersection signaling controller should be operating according to one among differing hierarchical condition categories, and issuance of instructions causing remote traffic signaling to lock in a particular state, such as, for example in a right of way state.

### CROSS-REFERENCE TO RELATED APPLICATIONS

This application is a continuation of the applicants' prior nonprovisional application titled Traffic Control System And Method Of Use, filed Apr. 9, 2015, application Ser. No. 14/683,102, which claims priority through: (i) the applicants' provisional application of the same title, Traffic Control System and Method of Use, filed Apr. 9, 2014, Application No. 61/977,530; (ii) applicants' provisional application of the same title, Traffic Control System and Method of Use, filed Aug. 6, 2014, Application No. 62/034,039; and (iii) the applicants' provisional application of the same title, Traffic Control System and Method of Use, filed on Apr. 9, 2015, Application No. 62/178,426 all of which provisional applications are hereby incorporated by reference in their entirety. In the event of any inconsistency between such prior patent applications and the present nonprovisional application (including without limitation any limiting aspects), the present nonprovisional application shall prevail.

### COPYRIGHT NOTICE

This patent document contains material subject to copyright protection. The copyright owner has no objection to the photocopy reproduction of the patent document or the patent disclosure in exactly the form it appears in the Patent and Trademark Office patent file or records, but otherwise reserves all copyright rights. The files included in the Computer Program Listing Appendix are subject to copyright protection and any use thereof, other than as part of the reproduction of the patent document or the patent disclosure, is strictly prohibited.

### FIELD OF DISCLOSURE

The present application relates to the technical field of traffic control systems and methods of use. Some embodiments are particularly suited for use in locations where very large vehicles, unusually dangerous vehicles, specifically-purposed vehicles, and the like, can be in use.

### APPLICANTS' VIEW OF SOME ASPECTS OF PRIOR ART

When multiple vehicles are travelling along intersecting trafficways, it can be desirable to provide instructions to the operators of one or more vehicles such that traffic flow is controlled, thus avoiding intersection conflicts and reducing the inefficiencies that can otherwise result from uncontrolled or minimally controlled traffic flow. Various types of simple traffic management strategies have been employed to control traffic flow, including such mechanisms as static signs, fixed pattern timed traffic lights, and the like. Such conventional systems generally failed to address the dynamic nature of traffic flow, such as changes to traffic volume for a given trafficway over time, resulting in traffic backups and general inefficiency.

Conventional signaling systems were sometimes augmented with sensors, calendaring, timing controls, and the like, in an attempt to partially mitigate some bottlenecks and inefficiencies resulting from certain types of changes to the traffic flow. Such approaches have exhibited limited effectiveness in increasing traffic flow efficiencies particularly due to technical limitations such as fixed signal patterns, execution of simple timing resets, non-specific vehicle presence detection (e.g., below-pavement weight sensors), and the like. Further, these existing technologies generally were not sophisticated enough to accommodate dynamic and contextually-specific purposes of particular areas or trafficways, such as, for example, enabling certain types of vehicles to proceed at certain times in order to achieve certain ends.

One type of proposed solution involved non-interruptive modification of normal signal operation processes, often by the generation and transmission of a priority request. U.S. Pat. No. 7,477,984 (“the '984 patent”), for example, is directed to such a traffic control system and method. According to the '984 patent, its system determines when a vehicle, such as a bus, arrives at a predetermined location, such as a bus stop. The '984 patent states that the location can be determined through a GPS device and a mobile system in a vehicle may identify when the bus is in the location, such as near a bus stop.

When the vehicle's mobile system determines that it has arrived at a particular predetermined location such as a bus stop, for example, the '984 patent states that the vehicle's mobile system issues a traffic signal priority request to a central system. The request includes a plurality among a variety of possible types of event information. The '984 patent states that the central system monitors and assesses the event information to determine whether to relay a “traffic signal priority” (TSP) request to a traffic light system at a remote traffic intersection.

Exemplary events include a bus arriving at a bus stop and being behind schedule, so that the bus issues a TSP request including this information to the central system. The central system assessment may determine that the traffic control light at an upcoming intersection should be green when the bus arrives at the intersection. In such an event, according to the '984 patent the central system can then forward the TSP request to the traffic light system at the remote intersection. This may be accomplished through, for example, adjusting the timing of normal signal operation. The '984 patent further states that the system can also monitor the bus entering and departing the intersection after travelling through it. The central system can then, according to the '984 patent, issue a TSP cancellation request to the traffic light system restoring the normal signal timing.

The '984 system is relatively complex, involving multiple layers of request generation and forwarding, and requiring the vehicle to initiate TSP requests. The TSP requests must then be processed at a central server, requiring processing time as well as requiring the vehicle to initiate the request needed to provide traffic light control. Reliance on vehicle issuance of TSP requests in combination with central system forwarding of requests, however, can result in an increased risk of failure of the vehicle-based system to issue, process, and execute a TSP request when necessary. This can be particularly problematic, and even life threatening, at certain types of intersections such as those at mining sites where haul trucks with limited visibility, which can be enormous in size, seek to have the right of way through an intersection when desired or needed.

To achieve reasonable vehicle safety near mining sites for example, vehicles such as haul trucks, may need to slow or stop at various intersections to reduce the risk of collision with other vehicles. At some sites, conventional traffic control methods often rely on intersection stop signs that are functionally passive since the signs do not adjust to changing traffic conditions or site needs, and require heightened alertness and activity on the part of all vehicle drivers, especially the haul truck drivers, and can depend to a high degree on adequate visibility in multiple directions. Stop and start cycles for haul trucks carrying heavy loads (e.g., 100-plus tons of ore, 240-plus tons of ore, etc.) can cause significant wear on vehicles and the trafficway, and can reduce overall fleet effectiveness. For example, continued stopping and starting of such a haul truck fleet can result in the moving of less ore, burning of extra fuel, generation of higher maintenance costs, and reduction in equipment life. Further, failure of a haul truck to stop properly at such an intersection can cause tremendous damage to other vehicles and their occupants.

Use of conventional TSP-based traffic event locating techniques, such as that described in the '984 patent, can be inadequate, particularly when utilized in industrial locations, such as a mining site. Such sites can be organized to serve unique purposes, sometimes involving somewhat less structured uses of trafficways by vehicles such as haul trucks, for example. One drawback to TSP request models is that they tend to operate within normal signal operation, modifying such operation in terms of resetting the normal signal cycle time. Simple modifications such as this can be inadequate for accomplishing efficient management of site-specific traffic.

By generally employing simplified, request-based, control strategies, TSP-based traffic control systems typically fail to adequately account for the multiple factors relevant to determining the most efficient ordering and timing of intersection access and traversal that would otherwise further the unique purposes of the site. For sites such as, for example, mining sites, there can be a variety of different types of vehicles and resources working in concert in order to obtain high production levels and output levels.

Conventional traffic management solutions generally lack mechanisms to perform multi-factor analysis, weighting, or both such that various resource types can be efficiently utilized within a particular environment. Such resources can include, for example, transporters of materials, (e.g., conveyers of material from a loading station to a processing station or to/from a temporary storage station), loading station equipment, temporary storage station equipment, material processing equipment, and the like. Failure to account for factors such as, for example, vehicle types, vehicle purposes, vehicle conditions, environmental conditions, and the relationships across various factors can reduce efficiency significantly and can work against the unique purpose of the site.

There is a need for a more sophisticated traffic flow control system and method that can address at least the above drawbacks of the current approaches and technologies.

### BRIEF SUMMARY OF SOME ASPECTS OF THE PRESENT SYSTEM AND METHODS

The applicants believe that they have discovered solutions to at least some of the issues and problems such as those noted above for prior systems such as the '984 system discussed previously. The applicants have invented a traffic control system that can include, at least in part, centralized traffic flow control mechanisms, such as a centralized detection engine, preference ranking engine, decision engine, and boundary engine that, in combination in whole or in part, can control traffic signaling states across one or more intersection or trafficways at a site. Centralization of ranking and preemption determinations can reduce or eliminate the error, risk, and intelligence limitations associated with request-based systems, such as the TSP request-based system described in the '984 patent.

In some implementations, the system determines if a particular type of vehicle, such as a very large truck, has arrived at a distance from an intersection. Upon determining that the vehicle has arrived at that distance, the system can then automatically send to the intersection preemptive traffic signaling instructions to interrupt normal signal operation and alter the traffic signaling state, causing the light for the vehicle to be, for example, green when the vehicle arrives at or sufficiently near the intersection. The system can further monitor the location of the vehicle to determine when it has sufficiently departed the intersection and then issue an instruction returning the traffic signaling state to a default state. Further, the system can provide a locking mechanism to prevent alteration of the system state during intersection traversal, avoiding safety risk conditions that might otherwise arise without such preference ordering controls.

In some instances, the system includes boundary detection mechanisms that can include, for example, GPS or other locators placed in vehicles, where the boundary penetration determination occurs on, for example, a central server. A transmitter associated with a given locator can transmit: (i) the location of the vehicle; and (ii) information sufficient to provide the ability to identify the vehicle and determine characteristics associated with the vehicle, the vehicle location, the vehicle destination, and the like. In some embodiments, the traffic control system can identify when a vehicle penetrates a boundary a certain distance from an intersection, assigns a preference rank to the vehicle when applicable, determines whether any safety conditions exist that supersede efficiency concerns, and transmits instructions to one or more traffic control indicators, such as traffic lights, at one or more intersections, thus directing traffic according, at least in part, to preference ranks that can be assigned to tracked vehicle(s) within an area of interest. This type of centralized detection, in connection with centralized preference ranking and preemptive traffic signal instruction selection, can remove dependencies on field-originated requests, resulting in safer and more efficient operations by accounting for an increased number of factors impacting safety and efficiency at the point where preemptive decisions are considered.

In some embodiments, the system may include one or more geo-fences, such as, for example, a first, larger geo-fence, to provide an early warning to the system of tracked vehicles which may be approaching an associated intersection, and a second, one or more sometimes smaller geo-fences providing additional proximity data relating to the vehicle's approach to the intersection. Some systems can also identify when a vehicle has departed the area defined by the boundaries of one or more geo-fences, such as a third, even smaller geo-fence defining the intersection boundaries and providing indication when a vehicle has entered and exited the intersection. In some applications, this can allow the system to terminate consideration of the tracked vehicle when directing signal behavior at or near the intersection, initially favoring safety-based traffic signaling states while allowing for timely engagement of efficiency-based traffic signaling states. This can result in improved safety at or near an intersection while reducing the impact of such concerns on achieving broad efficiency goals. Further, this, in conjunction with other state transition based features, can expedite timely balancing of cross-purposes at a given site.

Some systems utilize generally circular geo-fences. Other systems can use geo-fences having varying shapes, such as polygonal, poly-polygonal, or yet other shapes (including radiuses or irregular sections). Non-circular geofences can be helpful in more completely tracking vehicles at a site and directing operations of the lights at the intersection accordingly, providing more granular vehicle location information in relation to site areas. This can improve flexibility in signaling operations, thus increasing efficiency.

In certain instances, the traffic control system designates a trafficway as a primary trafficway having a default traffic signaling state that prefers the traffic on the primary trafficway. In some cases, this can be a right of way state allowing traffic on the primary trafficway to flow through intersections without stopping, without regard to specific attributes of the vehicles passing through the intersection. This mechanism can prefer a particular trafficway based on historical data, such data suggesting that higher throughput on that particular trafficway will forward an important immediate or overall goal of the site.

In some embodiments, the traffic control system effects state transition between multiple default signaling states, each related to specific trafficways and intersections. The traffic control system can provide right of way through an intersection by, for example, changing between two trafficway-specific default states. While, for example, an important site purpose is best served with a particular trafficway having right of way in the absence of preempting concerns, that trafficway can be designated as the primary trafficway with the associated traffic signal default state applied. When conditions change such that a secondary trafficway having the right of way would best serve an important site purpose, the secondary trafficway can be transitioned to become the primary trafficway with a different associated traffic signal default state applied. In some instances, the application of this sort of flexible modification can promote specific goals within a changing site environment, responding to such things as changes in traffic flow, changed conditions of services, and the like without undue reconfiguration expense.

In some embodiments, the traffic control system assigns one or more vehicles traveling on a controlled trafficway a preference rank specific to the trafficway, intersection, or both. Vehicle preference rank can be based on values associated with one or more among the type of vehicle involved, distance of the vehicle from or time for the vehicle to reach an intersection, the vehicle's destination, or other location, vehicle content, direction, and speed, weather and other environmental conditions (such as traffic way topography), the urgency of the vehicle's transportation needs such as waiting shovels, or any other associated element attribute. In some embodiments, preference rank attribute values are summed to obtain a preference rank for a vehicle. The system can vary preference ranks, the basis of the preference ranks, or both as a configuration change, as a dynamic real-time change, or both. In some instances, weighting mechanism, such as multiplier coefficients, further adjust the impact of one or more preference rank attribute values' impact on resulting vehicle preference rank. Vehicle preference ranking and weighting coefficients can provide flexibility in adjusting preference rank calculations and the resulting traffic signaling states, thus, in some instances, addressing the dynamic nature of traffic flow and improving response to changes in such dynamic flow. Further preference rank driven state transitioning, as well as primary trafficway default state transitioning can, alone or in combination, can reduce any of fuel waste, vehicle route travel times, wear and tear (e.g. on tires, brakes, transmissions, etc.), load loss, and operator stress.

In certain implementations, multiple state condition categories are assessed hierarchically and can include, for example, a normal condition category, a safety condition category, and a preference condition category. Hierarchical evaluation can occur such as, for example, effecting signal operation per the normal category states only in the absence of a preference condition, and effecting signal operation per the preference category state only the absence of a safety condition state. For example, the default state of primary trafficway can be in operation unless and until preference ranked vehicles are detected that result in transitions to a preemptive signal operation state. Further the preemptive signal operation states can be effected in the absence of, and until the detection of, a safety condition associated with a safety condition traffic signal state. This hierarchical approach can balance general operational simplicity with efficiency improvement strategies and safety considerations. This can result in greater overall efficiency without sacrificing safety. The intersection lighting system can be fixed or portable. In certain instances, a wireless controller, in communication with a remote server system, controls the intersection lighting system. The remote server system can collect data generated from use of the system, and analytics can be generated to provide information about system use. The data can be used to alter preference rankings, report about system efficacy, and the like, enhancing overall system performance in light of one or more site goals. The portability of signaling components can, in some instances, allow such components to be moved as site topology or site needs change, thus reducing costs associated with fixed location components.

In some embodiments, a mobile GPS tracking component is deployed in vehicles facilitating collection of tracking information. The GPS tracking component can be a single, small, lightweight, and economical device. This can be helpful in controlling traffic flow at particular locations, such as mining sites. For example, as differing types of vehicles arrive and depart a location, an operator can mount and remove the devices from the vehicles as desired. The operator need not rely on others to include these devices in the vehicles, and the operator can test the devices and monitor their operational status as desired at the particular location or elsewhere. This can reduce overall deployment and redeployment costs, as well as reduce the skill level required for certain maintenance and deployment activities.

Yet other capabilities can be added to the traffic control system based that further incorporates information collected by the mobile GPS device. For example, warning capabilities can be included, such as warning of a proximity emergency where two GPS devices are determined to be close to each other, travelling too rapidly toward each other or another position or structure, etc. Such factors can be defined as attributes applicable to preference rank determination, safety condition determinations, or both.

In some cases, the traffic control system utilizes time based techniques to track one or more vehicles. For example, wireless signals sent from one or more vehicles can include, or be indicative of, a location, direction, and speed. Based on the location, direction, and speed, a time to the intersection, destination, or other location for the vehicle may be determined. The traffic control system can include rules specific to one or more vehicles where antecedent conditions, such as time-based conditions, when interpreted, select a preemptive traffic signal instruction. This preemptive traffic signal instruction can be transmitted to one or more traffic signal controllers such that a particular vehicle is provided with preferred access to the intersection.

In some implementations, the traffic control system utilizes the preference ranking strategy to prefer vehicles in a first come, first serve basis, where vehicles receive a higher preference ranking based on relative proximity to the intersection (e.g., reach an outer geo-fence, reach a particular time to intersection, or both). In another example, preference rank for vehicles is determined in a way that reduces stopping of certain vehicles, such as, for example, loaded haul trucks. In yet another example, a later-approaching vehicle receives a higher preference ranking than an earlier approaching tracked vehicle, such as when the later approaching vehicle approaches the intersection trailing a vehicle with a higher preference rank than the earlier approaching vehicle. In some embodiments, the traffic control system checks for trailing tracked vehicles when a vehicle has approached, is crossing the intersection, or both, and maintains the traffic signal state until after a trailing tracked vehicle has cleared the intersection.

In other examples, tracked vehicles receive a high preference rank based on one or more element attributes, such as their identity, status, state, purpose, or the like. For example, transport vehicles having a high load status element attribute value (e.g., carrying heavy materials) may receive a higher preference rank than vehicles having a lower load status element attribute value (e.g., empty vehicles driving to a mine for pickup) to prevent stopping of heavier vehicles. In addition, or alternatively, vehicles having a lower load status element attribute value on their way to a waiting shovel may receive a higher preference rank than vehicles having a higher load status element attribute value carrying a load where there is a backup ahead.

The traffic control system may include one or more other advance warning devices. The advance warning devices can be positioned along the intersecting trafficways such that they are viewable or audible to vehicles as and/or before the vehicles begin approaching the intersection. In one example, an advance-warning device on the primary trafficway may display a slowdown sign for the primary trafficway traffic when based on executing a preemptive traffic signal rule preferring a vehicle on the secondary trafficway approaching the intersection. In another example, the advance warning devices may be configured to indicate the speed at which vehicles should approach or are approaching an intersection. An indicated speed may be set such that tracked vehicles that follow the speed sign will approach the intersection at a time and speed that minimizes stopping at the intersection.

Developing a solution to the long-standing problem of achieving a lower sustainable operational cost while increasing production levels has been elusive. This system addresses this, at least in part, by controlling the number and duty life-cycle, and hence the overall operational cost, of the various system components, and by also controlling those elements of the overall environment whose functions can be controlled and whose usage may constitute the “critical path” to the operation of the other elements of the environment. In some instances, this can support resource optimization strategies, such as facilitating higher system throughput by increasing the utilization of the highest preference rank elements, for example, those who have the highest idle-time cost, keeping them active and in use for increased amounts of time (i.e., minimizing idle time for high preference rank elements).

There are other novel aspects and features of the present specification. They will become apparent as the specification proceeds.

### BRIEF DESCRIPTION OF THE DRAWINGS

The applicants' preferred and other embodiments are disclosed in association with the accompanying Figures. In the Figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a diagram of some of the elements and resources for a mining site implementing a traffic control system.

FIG. 2 is a computer network or similar digital processing environment in which a portion of the traffic control system can be implemented.

FIG. 3 is a block diagram of the internal structure of a computer used in the computer network of FIG. 2.

FIG. 4 is an architecture diagram of the traffic control system that can be implemented, in part, on the computer network of FIG. 2.

FIG. 5 is a block diagram providing further detail for the component architecture of the communication and location hardware located in a vehicle, and the traffic controller hardware in communication with the vehicle hardware via the traffic control server system of FIG. 4.

FIG. 6 is a block diagram providing further detail for a notification subsystem in communication with the traffic control system of FIG. 4.

FIG. 7A through FIG. 7P are diagrams of some of the tables of the logical databases of FIG. 4.

FIG. 8A through FIG. 8C are drawings of various examples of inner boundary and outer boundary definitions defined by the traffic control system of FIG. 4.

FIG. 9A and FIG. 9B are drawings of various examples of complex boundary configurations defined by the traffic control system of FIG. 4.

FIG. 10 is a drawing of a mine site with inner boundary and outer boundary definitions imposed on the site by the traffic control system of FIG. 4.

FIG. 11A is a drawing of a mine site implementing the traffic control system of FIG. 4 that includes various mobile elements, passive elements, and service elements of FIG. 1.

FIG. 11B is a state diagram of a multi-state transition scheme implemented by the traffic control system of FIG. 4.

FIG. 12 is a flow diagram for a signal preemption process of the traffic control system of FIG. 4.

FIG. 13 is a flow drawing of the apply preemption process of FIG. 12.

FIG. 14 is a state diagram of a transition from a default state to a preemption state by the traffic control system of FIG. 4.

FIG. 15 is a state diagram of a transition from the preemption state of FIG. 14 to a default state by the traffic control system of FIG. 4.

### DETAILED DESCRIPTION OF SOME EMBODIMENTS

This disclosure is directed to traffic control systems and methods of use of such systems. The prior Brief Summary of Some Aspects of the Present System and Methods and the following specification provide examples, and are not limiting of the scope, applicability, or configuration set forth in claims, particularly as they may issue in this matter. Changes may be made in the function and arrangement of elements discussed without departing from the spirit and scope of the disclosure. Various embodiments may omit, substitute, or add various procedures or components as appropriate. For instance, the methods disclosed may be performed in an order different from that described, and various steps may be added, omitted, or combined. Also, features disclosed with respect to certain embodiments may be combined in or with other embodiments as well as features of other embodiments.

The term “traffic” as used in this application refers to the movement, as of vehicles or pedestrians, for example, through an area or along a route. The term “trafficway” as used in this application refers to a route or an area, at least a portion of which, is open to traffic. The term “boundary” as used in this application refers to boundaries, such as physical or virtual designators specifying areas of special interest. The term “geo-fence” as used in this application refers to a virtual perimeter for a geographic area, where the virtual perimeter can consist of, for example, one or more boundaries.

Certain embodiments of the traffic system and methods are described with reference to methods, apparatus (systems), and computer programs that can be implemented by computer program instructions. These computer program instructions can be provided to a processor of a computing device, such as a general purpose computer, special purpose computer, mobile computing device, or other programmable data processing apparatus to produce a particular machine, such that the instructions, which execute via the processor of the computing device, implement the acts specified herein to transform data from a first state to a second state, transmit data from one computing device to another computing device, and generate physical state transitions at one or more geographic locations, including, for example, at a trafficway intersection.

These computer program instructions can be stored in a computer-readable memory that can direct a computing device or other programmable data processing apparatus to operate in a particular manner, such that the instructions stored in the computer-readable memory produce an article of manufacture including instructions for implementing the acts specified herein. The computer program instructions may also be loaded onto a computing device or other programmable data processing apparatus to cause a series of operational steps to be performed on the computing device or other programmable apparatus to produce a computer-implemented process such that the instructions which execute on the computer or other programmable apparatus provide steps for implementing the acts specified herein.

The programming of the programmable apparatus creates a new machine, creating a special purpose computer once it is programmed that performs particular functions pursuant to instructions from program software. The traffic control system can be described in terms of a dedicated circuit or a process that emulates that circuit. The software processes of the traffic control system are, at least in part, interchangeable with a hardware circuit. This new machine can thus be implemented as a complex array of hardware circuits, programming that facilitates the unique functions of the traffic control system, or both.

The various illustrative logical blocks, modules, and algorithm steps described in connection with the embodiments disclosed herein can be implemented as electronic hardware, computer software, or combinations of both. To illustrate this interchangeability of hardware and software, various illustrative components, blocks, modules, and steps have sometimes been described generally in terms of their functionality. Whether such functionality is implemented as hardware or software depends upon the particular application and design constraints imposed on the overall system. The described functionality can be implemented in varying ways for each particular application and function, but such implementation decisions should not be interpreted as causing a departure from the scope of the disclosure.

The various illustrative logical blocks and modules described in connection with the embodiments disclosed herein can be implemented or performed with a general purpose processor, a specific purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices such as, for example, a combination of a DSP and a microprocessor, a plurality of microprocessors, one or more microprocessors in conjunction with a DSP core, or any other such configuration.

The blocks of the methods and algorithms described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of computer-readable storage medium known in the art. An exemplary storage medium is coupled to a processor such that the processor can read information from, and write information to, the storage medium. In the alternative, the storage medium can be integral to the processor. The processor and the storage medium can reside in an ASIC. The ASIC can reside in a computer terminal. In the alternative, the processor and the storage medium can reside as discrete components in a computer terminal.

Depending on the embodiment, certain acts, events, or functions of any of the methods described herein can be performed in a different sequence, can be added, merged, or left out altogether (e.g., not all described acts or events are necessary for the practice of the method), and otherwise mixed and matched as desired. Moreover, in certain embodiments, acts or events can be performed concurrently such as, for example, through multi-threaded processing, interrupt processing, or multiple processors or processor cores, rather than sequentially. Moreover, in certain embodiments, acts or events can be performed on alternate tiers or on alternate components within the architecture.

The traffic control system can implement a preemptive state transition model based on one or more state condition categories. In some embodiments, the state transition model includes a safety condition category, a preference condition category, and a normal condition category. The safety condition category can include state transition preemptive strategies based on one or more pre-defined preemptive traffic signal patterns, timing patterns, or both, initiated when a pre-defined safety condition exists or is detected, and where one or more tracked vehicles are detected in proximity to, or approaching towards, a controlled intersection. In some instances, the preemptive traffic signal patterns can be adjusted dynamically. Examples of safety conditions can include: (a) detecting an unsafe stopping distance accounting for the speed of a detected vehicle, weight of a detected vehicle, trafficway topography (e.g., slope), and the like; (b) detecting an emergency vehicle on route to or from an emergency situation; and (c) detecting of a visibility limitation relating to another vehicle.

The preemptive state transition model of the traffic control system can further implement a preference condition category including state transition preemptive strategies based, at least in part, one or more vehicles having an assigned preference rank, preferring a vehicle for purposes of improved efficiencies. In the absence of a superseding safety condition, pre-defined preemptive traffic signal patterns, timing patterns, or both associated with preferring a preference ranked vehicle, such as the highest ranked vehicle in a controlled area, can be initiated when the preferred vehicle is detected in proximity to, or approaching towards, a controlled intersection. In some instances, the preemptive traffic signal patterns can be adjusted dynamically. Examples of improved efficiencies can include, for example, reducing vehicle wear, reducing maintenance costs, increasing throughput, reducing fuel consumption, reducing trafficway and intersection wear, increasing equipment life, and the like.

In addition, the preemptive state transition model of the traffic control system can implement a normal condition category including a pre-defined state of default operation that can include, for example, a pre-defined signaling pattern, one or more pre-defined timing patterns, and a pre-defined primary trafficway designation. This pre-defined default state can operate in the absence of preemptive traffic signaling instruction received as a result of detection of a safety condition or detection of a preference ranked vehicle.

In some instances, the pre-defined default state can be determined based on measured, expected traffic patterns, predicted traffic patterns or both. The traffic control system may use vehicle traffic data to determine the primary trafficway such that the default state reduces stopping of tracked vehicles at the intersection. For example, the traffic control system can generate the tracked vehicle traffic data (e.g., in real-time) based on the wireless telemetry (or other) signals from tracked vehicles near the intersection received by the traffic control system. Giving the trafficway with a higher volume of vehicles of, for example, a particular type primary status can decrease slowing or stopping of such vehicles. In some implementations, this can be accomplished by:
a) collecting tracked vehicle data;
b) determining the trafficway associated with said collected tracked vehicle data;
c) calculating the number of vehicle passes consistent with a particular vehicle criteria for one or more trafficways for a particular time segment;
d) comparing said calculated numbers for multiple trafficways;
e) determining the trafficway with the highest number of vehicle passes; and
f) setting the primary_trafficway_id value in the Intersection table to the trafficway_id in the Trafficway table associated said determined trafficway.

In certain implementations of the preemptive state transition model, the state condition categories are organized hierarchically with respect to analysis of conditions and application of rules. Where evaluation of tracked vehicle data is continuous, the hierarchical analysis can begin by determining whether data received from a tracked vehicle indicates the vehicle has penetrated the boundary of a controlled area. Where such penetration has not occurred and where there are no tracked vehicles traversing an area within an associated geo-fence, the pre-defined state of default operation can be maintained or obtained. In the case where such penetration has occurred, a determination can be made whether a safety condition is present, and if so, the rule or instruction associated with the safety condition can be retrieved and applied. If no safety condition is detected, a determination can be made if multiple tracked vehicles are within the associated geo-fence area, or across coordinated geo-fences. Where there are multiple tracked vehicles present, preference rank values can be determined and assigned to each vehicle, and the preemption instruction associated with the vehicle having the highest preference rank can be retrieved and applied.

Upon detection of an egress event at a controlled intersection, the multiple vehicle detection analysis can repeat, and if such state is again detected, the same preference ranking process and rule application decision process can execute. If multiple vehicles are not detected, a determination can be made whether a single tracked vehicle is present within a geo-fence area or in a coordinated geo-fence area. If so, it can be determined if an associated rule is applicable, and if so, a preemptive traffic signal instruction resulting from processing of the rule can be sent to the traffic controller. If there is no applicable rule, then the default traffic signal instruction can be sent to the traffic signal controller reinstituting the default signal operation. Similarly, if no tracked vehicle is detected, the default traffic signal instruction can be sent to the traffic signal controller.

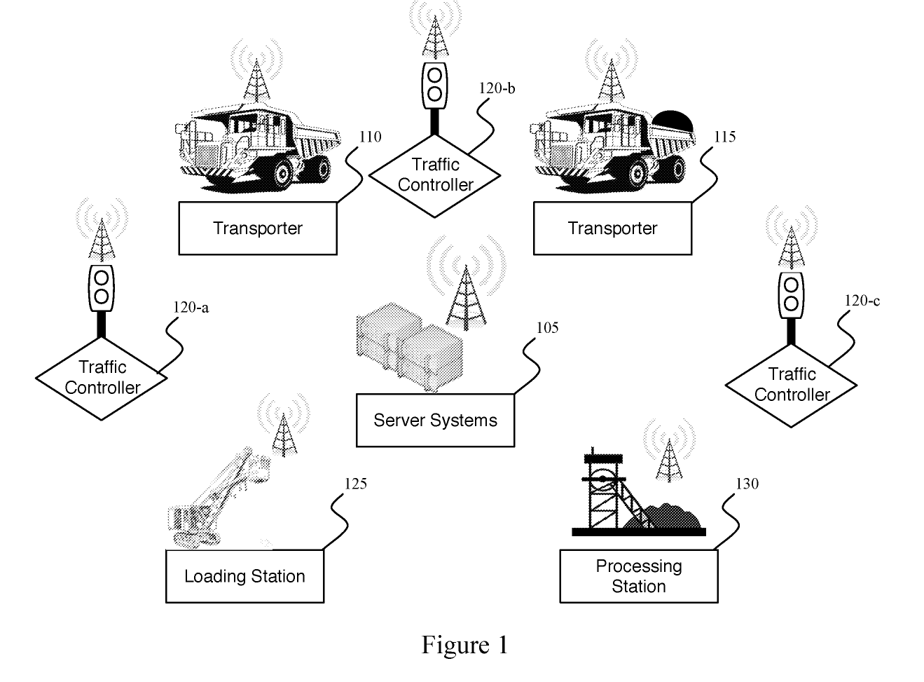

Referring now to FIG. 1, various elements and resources can be controlled by, and communicated with, server-based systems 105 of the traffic control system, including mobile elements such as unloaded transporter vehicles 110, loaded transporter vehicles 115, control elements such as traffic signals or beacons 120-a, 120-b, 120-c, and service elements such as loading stations 125 and processing stations 130. Passive elements such as roads and intersections (not shown) are not themselves controlled, although for purposes of this application, a “controlled intersection,” “controlled area,” or “controlled trafficway” is a passive element included within an area where other types of elements are controlled.

The mobile elements of the environment can include at least one tracked vehicle and one or more non-tracked vehicles. For purposes of this application, “tracked vehicles” are vehicles that are tracked by the traffic control system. Tracking can include location tracking, as well as the tracking of changes to other vehicle element attributes. In some instances, tracked vehicles include transport vehicles, such as, for example, haul trucks. Elements can have one or more static element attributes, dynamic element attributes, or both. Transport vehicles for example, can have static element attributes, such as size and shape, as well as dynamic element attributes, such as location and velocity. Other mobile element attributes can include, for example:
a) total load capacity;
b) current load;
c) loading time;
d) unloading time;
e) refueling time;
f) maintenance time;
g) maximum travel velocity;
h) current velocity;
i) identifying characteristics (e.g., visual markings);
j) maximum acceleration rate;
k) maximum deceleration rate;
l) stopping distances;
m) fuel consumption rate;
n) fuel capacity;
o) maintenance duty cycle (i.e., the duration it is capable of performing its function and the duration of its required maintenance/service down time); and
p) driver's visibility range.

Element attribute values can be impacted by one or more other element attributes, such as, for example, passive element attributes. Passive element attributes can include, for example topography characteristics, such as the slope of the path being traveled and visibility on curves and at intersections. These attributes, along with mobile element attributes, such as fuel consumption rate characteristics and current load characteristics, can affect, for example:
a) maximum travel velocity;
b) maximum acceleration rate; and
c) maximum deceleration rate.

In some instances, tracked vehicles include vehicles not involved in a materials transport function. Monitoring and managing non-transport vehicles can indirectly improve overall system efficiency with respect to transport vehicle efficiency. For example, managing non-transport vehicles can reduce congestion, which can allow transporters to function at a more efficient average speed. In some instances, monitoring and control of non-transport vehicles is implemented in the same manner as that of transport vehicles.

In some cases, the service elements of the environment perform one or more functions at one or more locations. Service element attributes can include, for example:
a) element function, such as loading;
b) element performance rate; and
c) element maintenance duty cycle.

Service elements can have, in some cases, a fixed size and a geographic location. The location and size of each service element can be defined in terms of, alone or in combination with, any one of a number of coordinate systems. Service elements can include, for example:
a) loading stations, such as transporter loading facilities. Loading station attributes can include, for example:
   1) the maximum operation rate; and
   2) historical operation rate;
b) unloading stations, such as transporter unloading facilities. Unloading station attributes can include, for example:
   1) the maximum operation rate; and
   2) historical operation rate;
c) temporary storage stations, such as temporary storage facilities for materials that cannot be transported to processing stations, for which temporary storage stations may also function, in certain cases, as loading stations, unloading stations, or both;
d) processing stations, such as facilities where transporters loads are unloaded and processed where, in some instances, processing stations may also function as loading stations for the transportation of “processed” loads to additional processing stations; and
e) refueling & maintenance locations, such as facilities in which the transporters are supplied with fuel, undergo periodic maintenance or both where, in some configurations, refueling is accomplished via mobile tankers that are also resources that can be managed.

In some instances, passive elements of the environment have a fixed size, geographic location, or both. The location and size of each can be defined in terms of a coordinate system. Passive elements can include, for example:
a) roads, such as the paths or routes traveled by the mobile elements; and
b) boundaries, such as physical or virtual designators specifying areas of special interest.

For example, in some instances, geo-fences are defined for all approaches to one or more intersections, as well as all entry points for the intersection itself. Similarly, road sections leading to and from loading facilities and unloading facilities can also be defined by geo-fences. In some instances, detected global position system coordinates for one or more vehicles are intermittently, regularly, or continually evaluated to determine if the coordinates fall within a geo-fence area. Alternatively or in addition, motion detection mechanisms, such as passive infrared motion sensors, active infrared motion sensors, visible light motion sensors, contact motion sensors, and the like can be used to define a boundary, detect entry to a bounded area, or both.

Traffic controller elements of the environment can include, for example, traffic signals and signage. In some embodiments, the traffic signal controller and the traffic-directing devices, such as, for example, traffic signal lights, are transportable for movement to, and use at, differing locations. For example, the trafficway layouts of mining sites are often subject to change, with some trafficways being semi-permanent or temporary trafficways. As a result, it can be useful for traffic control components to be moveable to and from different intersections as desired with minimal reprogramming. For example, the primary trafficway and default state of the intersection-associated traffic signal may be determined based on historical traffic data and location data indicating the location of the intersection and the like. Alternatively, the moveable components can themselves include GPS locating and transmission systems so that the traffic control system can automatically receive the revised location data.

In some implementations, the intersection traffic light controller can be configured to control multiple intersections and, in addition if desired, synchronize the operation of traffic control devices at the differing intersections, improving the efficiency of tracked vehicle flow. The traffic controller, in communication with the traffic control servers system, may use tracked vehicle traffic data, scheduling data, mining site data, tracked vehicle data, etc. to determine, at least in part, the primary trafficway, the default traffic signaling state for the controlled intersection, and otherwise determine when to change or activate a preemptive traffic signaling change in response to a preemptive traffic signal instruction received from the traffic control server systems. In one example, a mining location and a material delivery destination site may be, of particular importance or exhibit high traffic volume and, as such, a trafficway between the mine and the material destination site may be determined to be the primary trafficway at each controlled intersection. Accordingly, the default signaling state may prefer the primary trafficway over the secondary trafficway at multiple intersections.

In certain embodiments, one or more environment elements are monitored, managed, or both where such monitoring and management can, at least in part, facilitate improved efficiency, safety, or both. In some mining implementations of the system, these elements include, for example:
a) loading stations;
b) processing stations;
c) temporary storage stations; and
d) transporters.

In some embodiments, any or all elements, element types, or element attributes are assigned a preference rank attribute value. A preference rank attribute value is an assigned value used, at least in part, to calculate the preference rank for a mobile element. Preference ranks can vary for different types of elements, across different instances of the same type of element, or both. Preference rank attribute value assignments can be either static or dynamic. For example, different element attributes can be assigned different preference rank values at different times based on, for example, the presence or absence of other factors, managerial policy decisions, and the like. Preference rank can be used for, among other things, ordering selection or processing of preemptions options. Preference rankings can be further combined with weighting factors as part of the preemption option processing and selection. In some instances, a preference ranking attribute value, preference rank, or both, are continuous variables used for ordering functions, weighting functions, or both.

In some instances, the traffic control system recognizes and analyzes various elements, the combination of some subset of the elements creating an environment. These elements can be categorized into one or more types, such as mobile elements, service elements, control elements, and passive elements. In certain cases, an element belongs to multiple categories, such as both mobile element and service element. Elements can, in turn, be associated with one or more attributes. Preference rank can be calculated by, for example, summing preference values assigned to one or more element attributes. Where a transport vehicle element load attribute is set to true, a numeric value can be assigned, such as value of 5. Additionally, where a shovel is waiting with materials to be loaded at the transport vehicle destination, another numeric value can be assigned, such as a value of 6. Assigned attribute values can be summed to obtain a preference rank value, such as a numeric value, which can then be assigned to the vehicle.

In some embodiments, the preference calculation is further augmented with the incorporation of one or more weighting coefficients. For example, in addition to the example just described, where a transport vehicle element load attribute is set to false and a waiting shovel element attribute is set to true, a weighting coefficient can be assigned. This weighting factor can be implemented as, for example, a multiplier, a percentage factor, an additional value amount, and the like. This weighting factor can then serve to weigh one element attribute value higher or lower in relation to another element attribute values beyond the simple difference in the assigned attribute values. This can allow for dynamic weighting adjustments without modification to the underlying attribute value. Weighting factors can be persistently stored as values associated with element attributes, values associated with attributes within a rule definition, or both.

In certain instances, based, at least in part, upon the order of preference rank, weighting factors, or both, efficiencies of operation can be obtained, such as, for example:
a) minimizing the number of loading stations, commensurate with the required production levels, while maximizing the utilization of each;
b) minimizing the number of processing stations, commensurate with the required production levels, while maximizing the utilization of each;
c) minimizing the number of temporary storage stations required, while maximizing the utilization of each; and
d) minimizing the number of transporters, while maximizing the utilization of each.

Preference rank can be used, at least in part, to determine which of the multiple tracked vehicles may proceed to or enter an intersection at a given point in time. Similarly, when multiple tracked vehicles are prepared to access a specific service element, preference rank can act as a participating factor in determining the timing and order of access by, for example, determining the applicable preemptive traffic signal instruction to be transmitted to a traffic controller. This determination can be made using a rule definition that selects a preemptive traffic signal instruction based on, for example, matching one more attributes with the rule's antecedent conditions. These antecedent conditions can include, for example, one or more vehicle element attributes, one or more passive element attributes, or both.

In some embodiments, a rule definition that selects a preemptive traffic signal instruction for a preference rank selected vehicle can consist of the following structure:
IF
(trafficway=[pre-defined trafficway]) AND (intersection=[pre-defined intersection])
AND (vehicle attribute n=[pre-defined attribute state])
THEN
pre-emptive traffic signal instruction=[pre-defined preemptive traffic signal instruction]
   As an example, a preemption selection rule can be constructed where, for the vehicle with the highest preference value, if the trafficway is the Mill Road East trafficway, the intersection is the Mill Road/Dig Road intersection, the vehicle type is a haul truck, the vehicle location is at least 100 meters inside the west boundary, and the vehicle velocity is 40 mph, then the preemptive traffic signal instruction sent to the traffic controller directs the signal light to signal intersection access to the haul truck while stopping all intersecting traffic.

In some embodiments, the traffic control system implements one or more canned preemptive traffic signaling rules. These can include canned rules such as, for example:
a) detect the presence of a haul truck in the vicinity of an intersection or if a haul truck has entered an intersection using position, heading, and speed data captured by and retrieved from the dispatch system;
b) when a haul truck is detected to be stopped in an intersection, all beacons at that intersection flash red until the stopped truck is removed from the intersection;
c) when the GPS location of a haul truck is lost after the truck has been determined to be in the vicinity of an intersection, execute timers to continue preemption signaling;
d) determine that a haul truck is approaching an intersection when the haul truck is a pre-defined number of seconds from entering the intersection based on current speed and including a start time delay with, or executing a time delay in advance of sending, preemptive traffic signaling instructions;
e) implement a first-in-first-out order when vehicles have the same preference rank; and
f) when a haul truck is stopped due to, at least in part, another haul truck approaching the intersection on the intersecting street, the stopped haul truck shall not be allowed to proceed until all haul trucks approaching the intersection on the intersecting street have cleared the intersection, thus, in some implementation, reducing the total number of stops made by all haul trucks.

In certain embodiments, a combination of hardware and software regulate aspects of the tracked vehicles travel patterns and behaviors. Specifically, the control system can effect preemptive control over the traffic controllers. For example, at a traffic signal regulated intersection, the control system can interrupt the traffic signal pattern associated with the default signaling state, transitioning to provide a preemptive signaling state that may include a proceed signal to a tracked vehicle that has a higher current preference rank, and a stop signal or a speed adjustment indication to a vehicle that has a lower preference rank. In some cases, the preference rank of a tracked vehicle can be dynamically adjusted based on a preference rank of associated service elements, such as the destination loading station of one or more of the tracked vehicles. By dynamically determining relative preference ranks and preemptively regulating the traffic controllers through, for example, state transitions, the control can increase utilization of one or more elements, such as the loading stations, processing stations, temporary storage stations, and, the tracked vehicles themselves.

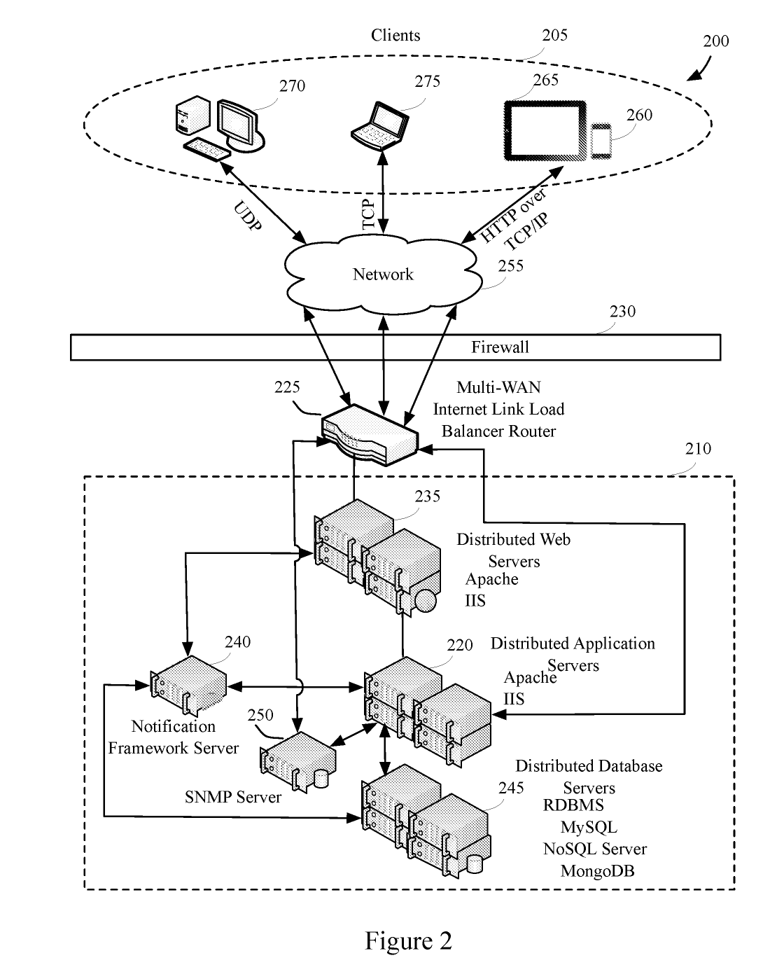

Referring now to FIG. 2, one embodiment of a computer network or similar digital processing environment 200 in which a portion of the traffic control system and method can be implemented is shown. Portions of the present systems and methods can also run on different architectures that include a LAN, WAN, stand-alone PC, stand-alone mobile device, a stand-alone, clustered, or networked mini or mainframe computers, etc. The traffic control system and method of use can be distributed on multiple computers and devices 205, 210.

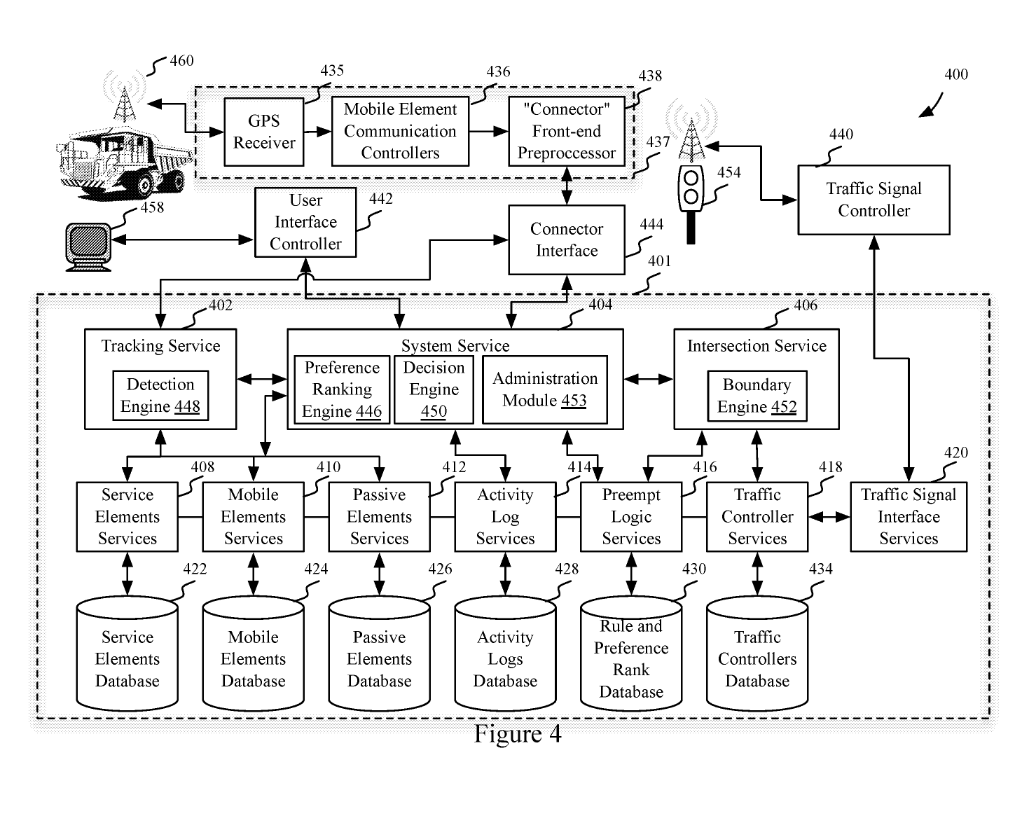

FIG. 2 is representative of many specific computing arrangements that can support the system and method disclosed. In one embodiment, at least some of the software implementing the traffic control system runs in the Windows® environment. In another embodiment, at least some of the software is implemented to run in other environments, such as Linux®, UNIX®, or in any hardware environments having enough power to support timely operation of software such as that identified in FIG. 4. In some implementations of a mining application of the traffic control system, a standalone executable is installed and runs as a Windows Service on a server running the Windows® operating system 220. In an alternate embodiment, one or more computers are deployed as virtual instances rather than physical computers.

A load balancing router 225, such as for example, the Peplink® Multi-Wan Router, can distribute traffic inside a firewall 230 to and from web server computers 235, application servers 220, or both. In some deployments, these webservers 235 are distributed instances of a Windows® IIS web server. A notification framework server 240 may be communicatively coupled to one or more of the web servers 235, application servers 220, and/or database servers 245. In some deployments, the application servers 220 are running instances of Windows® IIS web server and/or the Windows® .NET framework. The application servers 220 are communicatively coupled to computers 240, 245, 250 hosting one or more from the group including persistent data stores, snmp processes, or notification frameworks. The data stores can be distributed databases such as, for example, MongoDB® or MySQL® or the native operating system's file/folder structure.

Client computing devices of various types 205 can connect to a remote server infrastructure 210 via a network 255 over a communication protocol. All computers can pass information as one or more from the group of unstructured data, structured files, structured data streams such as, for example, XML, structured data objects, such as JSON, and/or structured messages. Client computing devices 260, 265, 270, 275 may communicate over various protocols such as, for example, UDP, TCP/IP, and/or HTTP/S over TCP/IP.

Client computing devices 205 and server computers 210 provide processing, storage, and input/output devices executing application programs. Client computing devices 205 can also be linked through communications network 255 to other computing devices, including other client devices/processes 205 and server computers 210. The network 255 can be a local area network and/or a wide area network that is part of a remote access network, a global network (e.g., the Internet), a worldwide collection of computers, and/or gateways that currently use respective protocols (TCP/IP, UDP, etc.) to communicate with one another. Multiple client computer devices 205 may each execute and operate instances of one or more of the applications accessing the traffic control system servers.

On reading this disclosure, those of skill in the art will recognize that many of the components discussed as separate units may be combined into one unit and an individual unit may be split into several different units. Further, the various functions could be contained in and/or performed on one computer or spread over several networked computers and/or devices. The identified components may be upgraded and replaced as associated technology improves and advances are made in computing technology.

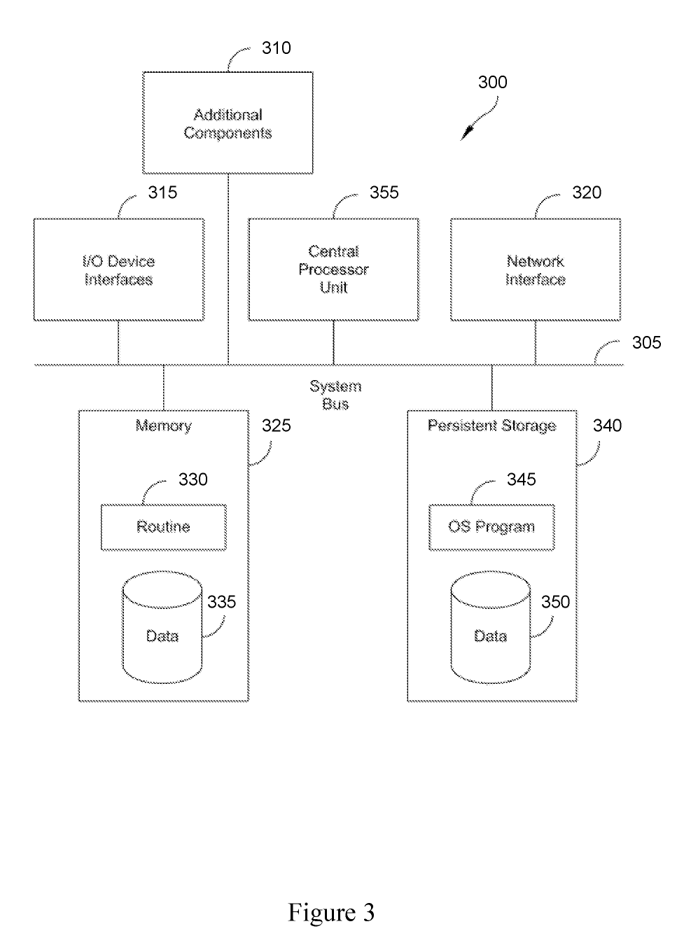

Referring now to FIG. 3, each component of the system 300 is connected to a system bus 305, providing a set of hardware lines used for data transfer among the components of a computer or processing system. Also connected to the bus 305 are additional components 310 of the traffic control system, such as additional memory storage, digital processors, network adapters, and I/O devices. The bus 305 is a shared conduit connecting different elements of a computer system (e.g., processor, disk storage, memory, input/output ports, network ports, etc.) and enabling transfer of information between the elements. An I/O device interface 315 is attached to system bus 305 in order to connect various input and output devices (e.g., keyboard, mouse, touch-screens, displays, printers, speakers, etc.) to the traffic control system. A network interface 320 allows the computer to connect to various other devices attached to a network 230 (e.g., see FIG. 2). A memory 325 provides volatile storage for computer software instructions 330 and data 335 used to implement methods employed by the system disclosed herein. Disk storage 340 provides non-volatile storage for computer software instructions 345 and data 350 used to implement an embodiment of the present disclosure. A central processor unit 355 is also attached to system bus 305 and provides for the execution of computer instructions.

In one embodiment, the processor routines 330 and data 335 are a computer program product, including a computer readable medium (e.g., a removable storage medium such as one or more DVDROM's, CD-ROM's, diskettes, tapes, etc.) that provides at least a portion of the software instructions for the system. A computer program product that combines routines 330 and data 335 may be installed by any suitable software installation procedure, as is well known in the art. In another embodiment, at least a portion of the software instructions may also be downloaded over a cable, communication, and/or wireless connection.

Referring now to FIG. 4, in some embodiments, the traffic control system includes various communication and control components such as, for example:
a) traffic control system server services 402-420;
b) traffic control system logical databases 422-434;
c) connector components 438, 444;
d) user interface controller 442;
e) preference ranking engine 446;
f) detection engine 448;
g) decision engine 450;
h) boundary engine 452;
i) administration module 453;
j) mobile element location tracking and communication components 435, 436;
k) traffic controller state transition and communication components 440;
l) traffic signal 454; and
m) service element state detection and communication components (not shown).

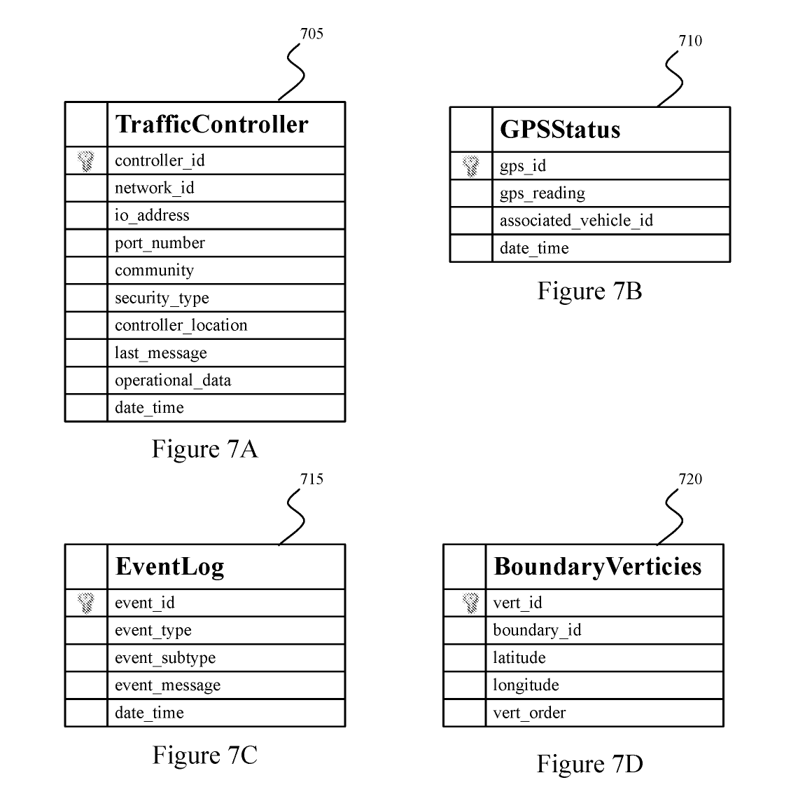

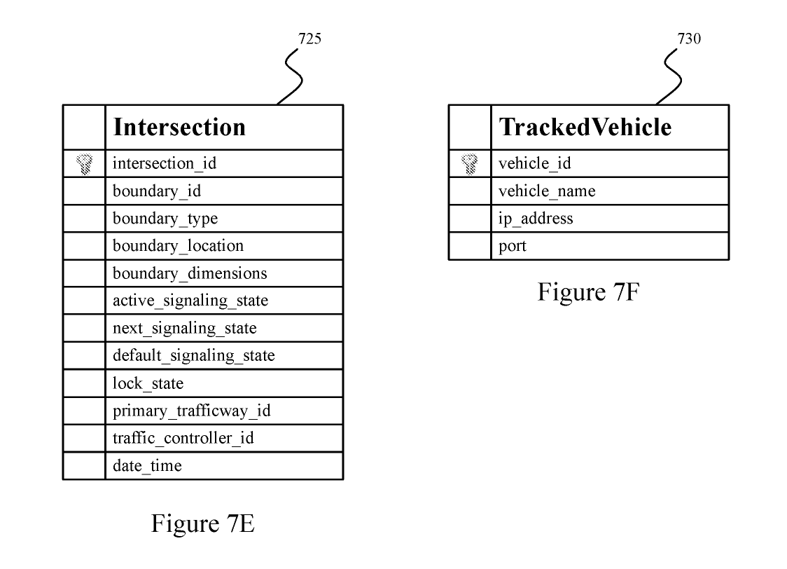

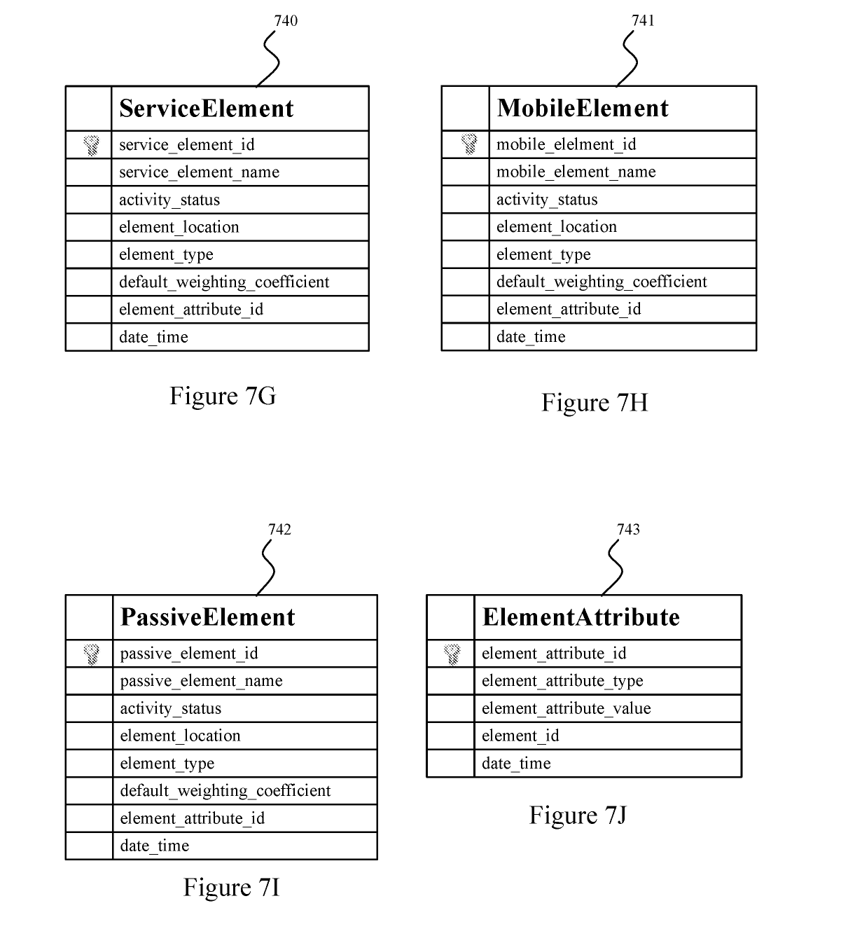

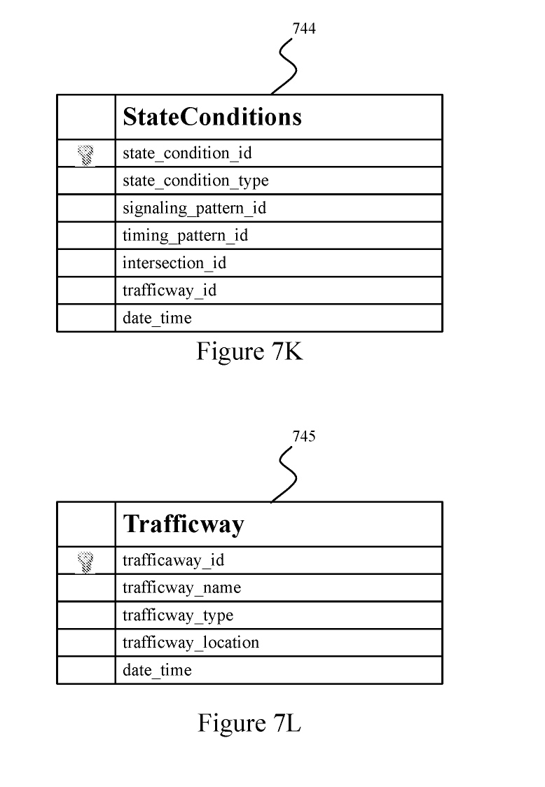

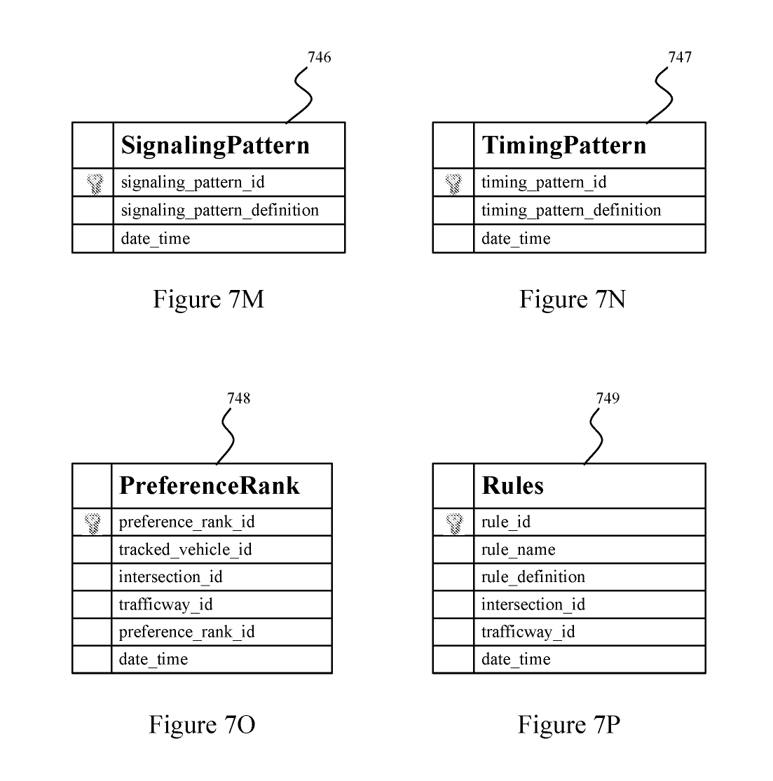

In certain instances, the traffic control system 400 us useable at a mining site, generally. In one embodiment of this type of system 400, the mining site includes haul trucks 110 (e.g., see FIG. 1), having GPS receiver devices 435 in communication with mobile element communication controllers 436 and connector front end preprocessors for facilitating transmission of mobile element data to a traffic control system server service 404 via a connector interface 444. The traffic control system 400 can further include traffic signal controllers 440 controlling traffic signals 454. The traffic signal controller can receive traffic signaling instructions from a traffic controller service 418 via a traffic signal interface service 420. In some instances, the traffic controller service 418 and traffic signal interface service 420 are supported, at least in part, by access to data stored in a traffic controller database 434. Data stored in the traffic controller database 434 may be stored in one or more relational database tables, and can include, among other data, traffic controller identification, attribute, and communication information 705 (e.g., see FIG. 7A), traffic signaling default state assignment, and traffic signal location data or reference identifiers.

The traffic control system 400 can include a variety of high-level services 402, 404, 406 supported by numerous lower level system services 408, 410, 412, 414, 416, 418, 420 along with various engines 446, 448, 450, 452 and modules 453. A tracking service 402 can receive location data from mobile element communication controllers 436 via a connector interface 444, where a detection engine 448 transforms and compares the received location data to boundary locations and boundary-defined areas retrieved from the BoundaryVerticies table 720 (e.g., see FIG. 7D), determining if the location constitutes of an event, and is within a defined controlled location, or both. This service 402 may log tracked vehicle data in a tracked vehicle table 730 (e.g., see FIG. 7F) which can be stored in the mobile elements database.

An intersection service 406 can provide various boundary and geo-fence definition and retrieval services, where a boundary engine 452 provides one or more methods to other services for the creation and retrieval of boundary information or boundary derivative information. For example, an administration module 453 can provide an interface for the definition of one or more coordinate-defined boundaries associated with an intersection via the intersection service 406. Boundary information can be stored in various tables, such as, among other tables, an intersection table 725 (e.g., see FIG. 7E) and a boundary vertices table 720 (e.g., see FIG. 7F). These tables, among others, can be implemented as part of the passive elements database 426.

A system service 404 can include engines and modules such as, for example, a preference ranking engine 446, a decision engine 450, and an administrative module 453. In some instances, the preference ranking engine 446 implements the logic and methods involved in retrieving preference rank attribute values from the various element databases 422, 424, 426, the rule and preference rank database 430, or both, and calculating the vehicle preference ranks. A decision engine 450 can provide, among other things, vehicle preference rank comparison logic, rule retrieval and rule processing services, state selection, and preemptive traffic signal instruction selection. This engine 450 may draw upon data from a number of databases including, but not limited to, the rule and preference rank database 430 and the element databases 422, 424, 426, and may receive preference rank data from the preference ranking engine 446 directly. In some instances, lower level services, such as the preempt logic service 416, perform some or all of the rule and preference rank processing, reducing the processing requirements of the higher-level system service 404. In certain implementations, the lower level services may use methods exposed by other lower-level services.

In addition, the system service 404 can include an administration module 453 for configuration and management of the system and system data. In some cases, the system service 404 includes event log processes that store and retrieve system activity in an event log table 715 (e.g., see FIG. 7C). In addition, the administrative module 453 can provide a data entry interface for receiving various element data for storage in a table, such as the service element intersection table 735 (e.g., see FIG. 7G) of the service elements database 422.

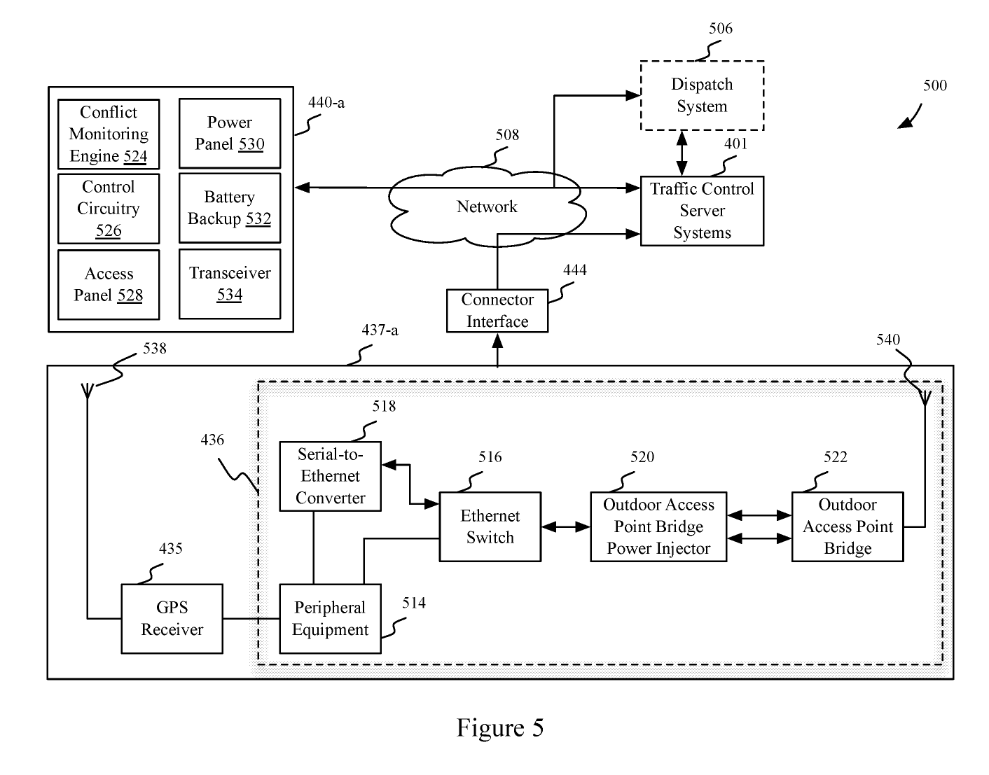

Referring now to FIG. 5, mobile elements, such as, for example, haul trucks 110, 115 (e.g., see FIG. 1), can include a hardware component set 437-a that includes a GPS receiver 435 and a communication controller 436. In some embodiments the GPS receiver 435 in such a truck can include a Caterpillar MS952 GPS transceiver communicatively coupled to other network transmission equipment, generally 514, for generating a transmission, such as, for example, a UDP transmission, over a local Wi-Fi network 508 via a connector interface 444 to the traffic control server system 401.

The communication controller 436 installed in, or associated with, a mobile element can include various components facilitating communication with the traffic control servers systems 401 via a connector interface 444, such as, for example:
a) peripheral communication equipment 514;
b) a serial-to-Ethernet converter 518 for converting the serial output from the GPS receiver 435 and peripheral communication equipment 514 to Ethernet-compatible format;
c) an Ethernet switch 516 for managing Ethernet traffic among various components (e.g. 10/100 Mbps Ethernet Switch);
d) an outdoor access point bridge power injector 520 for powering an outdoor access point bridge (e.g., Cisco Aironet Bridge Power Injector);
e) an outdoor access point bridge 522 (Cisco Aironet 12010 Series); and
f) an antenna 540.

In certain implementations of the system, an intersection traffic controller 440-a is located at each of one or more intersections at a local site, such as a mining site, controlling one or more traffic signals 454 (e.g., see FIG. 4) at the intersection. For example, traffic controllers can be located at each intersection through which a haul truck or other types of vehicles may travel. In this regard, the traffic controllers can be located remotely from an intersection and associated control intersection lights through a wired connection, wireless connection, or both.

The traffic controller 440-a can include control circuitry 526 including a computer processor and controller, a conflict monitoring engine 524, a power panel 530, a backup battery 532, an access panel 528, and a transceiver 534, such as a Wi-Fi transceiver. In the particular embodiment of FIG. 5, a Wi-Fi transceiver can be in communication with an optional dispatch server system 506, which is in communication with the traffic control system 401 or at least components of the traffic control system 136 where such components use telemetry data and issue commands for receipt by the traffic controller 440-a.

In some embodiments, the controller 440-a runs computing software and issues commands to control the associated traffic lights, managing communication from the traffic control server systems 401, such as receiving preemption instructions. The conflict monitoring engine 524 monitors the outputs of the computer controller, and if a fault is detected (e.g., lost communication with the traffic control server systems 401), the conflict monitoring engine 524 places the intersection in a pre-defined state, such as, for example, a flashing state where signals on one or more trafficways flash yellow, such as a primary trafficway, and where signals on one or more trafficways flash red, such as a secondary trafficway.

In addition, or alternatively, the traffic controller 440-a includes an access panel 528 providing a manual interface for engaging a pre-defined state. A power panel 530 can revert operation from a preemptive state to the normal, non-preemptive state when a loss of AC power is detected or the battery backup 532 is engaged.

The power panel 530 provides primary AC power to the traffic controller 440-a and the associated lights. In the event of loss of primary AC power, a battery backup 532 provides back-up power to the power panel 530 and, in turn, the traffic controller 440-a and its associated lights (or other traffic control or local warning devices).

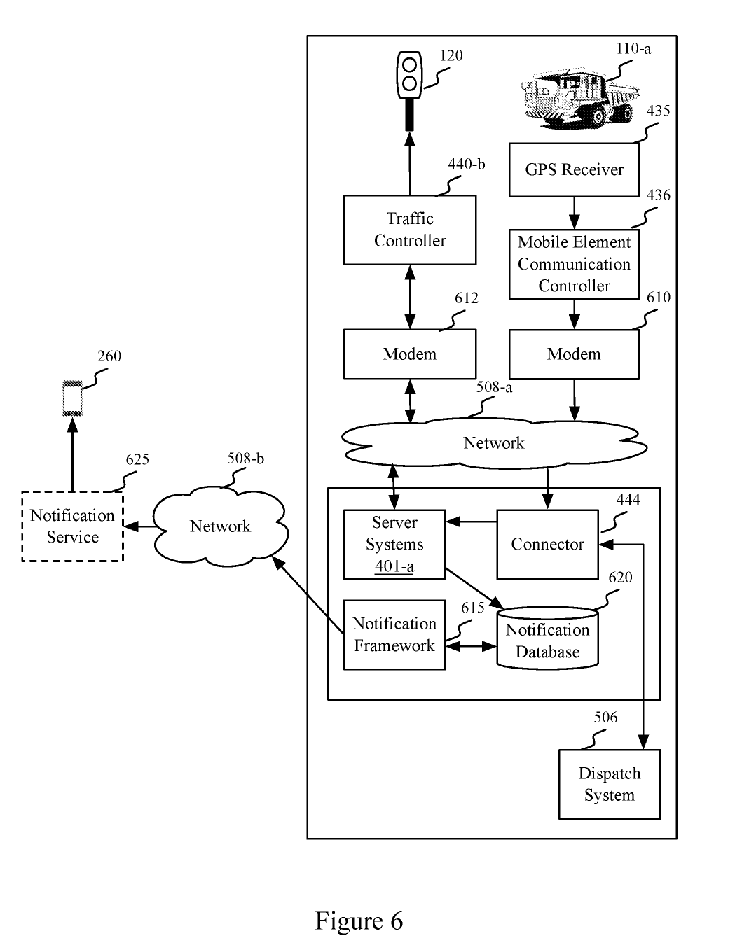

Referring now to FIG. 6, in certain embodiments the traffic control server systems 401-a are in communication with a local connector application 444 for facilitating communication with mobile elements such as haul trucks 110-a and controller elements such as traffic beacons 120. Local haul trucks (e.g., 110-a) can stream haul truck GPS telemetry data (which can include, for example, the haul truck position, speed, and the location of the truck 110-a) through a network connection, such as a wireless connection, to the connector application 444, the connector application 444 converting, for example, longitudinal and latitudinal truck position data to x-y coordinates. The connector application 444, can transmit or stream the converted telemetry data for the trucks to the traffic control server system 401-a, which can then utilize that telemetry data to determine when to perform certain operations, such as sending preemption instructions to local traffic controllers 440-b over a local Wi-Fi network 508-a. In some instances, the communication is further facilitated by one or more modems 610, 612, communicatively coupled to the element controllers 436, 440-b.

In some implementations, the system includes a notification framework 615 that can engage in variety of types of wireless communications regarding locally stored data 620 with remote systems, such as, for example, remote notification services 625, via the Internet 508-b. These remote notification services 625 can, in turn, generate and transmit one or more notifications to remote devices such as, for example, a mobile device 260. The connector application 444 can also transmit information to, receive information from, or both, a separate dispatch application 506 system through a wired connection, unwired connection, or other connection technique.

An example of a TrafficController table 705 in FIG. 7A stores the identities and communication information of one or more traffic controllers 440, such as traffic controller location, specific operating characteristics, and the state of each the communication delivered to the target device. Properties (i.e. columns) of the TrafficController table 705 can include:
a) controller_id;
b) network_id;
c) io_address;
d) port_number;
e) community;
f) security_type;
g) controller_location;
h) last_message;
i) operational_data; and
j) date_time.

An example of a GPS Status table 710 in FIG. 7B stores positioning and location information. Properties (i.e. columns) of the GPSStatus table 710 can include:
a) gps_id;
b) gps_reading;
c) associated_vehicle_id; and
d) date_time.

An example of an EventLog table 715 as shown in FIG. 7C stores the audit trail logs for one or more system events, such as, for example, time-date stamped states, state changes, communications received, instructions issued by the system, and error conditions. Properties (i.e. columns) of the EventLog table 715 can include:
a) event_id;
b) event_type;
c) event_subtype;
d) event_message; and
e) date_time.

An example of a BoundaryVerticies table 720 in FIG. 7D stores boundary information and definitions. Properties (i.e. columns) of the BoundaryVerticies table 720 can include:
a) vert_id;
b) boundary_id;
c) latitude;
d) longitude; and
e) vert_order.

An example of an Intersection table 725 in FIG. 7E stores intersection identification and definition information. Properties (i.e. columns) of the Intersection table 725 can include:
a) intersection_id;
b) boundary_id;
c) boundary_type;
d) boundary_location;
e) boundary_dimensions;
f) active_signaling_state;
g) next_signaling_state;
h) default_signaling_state;
i) lock_state;
j) primary_trafficway_id;
k) traffic_controller_id; and
l) date_time.

An example of a TrackedVehicle table 730 as shown in FIG. 7F stores tracked vehicle identification and communication information. Properties (i.e. columns) of the TrackedVehicle table 730 can include:
a) vehicle_id;
b) vehicle_name;
c) ip_address; and
d) port.

An example of a ServiceElement table 740 as shown in FIG. 7G stores the identities of one or more service elements, such as loading stations, unloading stations, and processing stations. Information can include location, operating characteristics, and state information. Properties (i.e. columns) of the ServiceElement table 740 can include:
a) service_element_id;
b) service_element_name;
c) activity_status;
d) element_location;
e) element_type;
f) default_weighting_coefficient;
g) element_attribute_id; and
h) date_time.

An example of a MobileElement table 741 as shown in FIG. 7H stores mobile element identification and tracking data for one or more mobile elements such as, for example, transporters. This database can include static data, such as GPS identifiers and communications IDs, as well as dynamic data, such as updated monitoring data, which may include location information, velocity information, load information, and the like. Properties (i.e. columns) of the MobileElement table 741 can include:
a) mobile_element_id;
b) mobile_element_name;
c) activity_status;
d) element_location;
e) element_type;
f) default_weighting_coefficient;
g) element_attribute_id; and
h) date_time

An example of a PassiveElement table 742 as shown in FIG. 7I stores the identities and specifications of one or more passive elements, such as, for example, roads, boundaries, and the like. Information can include element_location, element shape, defining characteristics, and state information. Properties (i.e. columns) of the PassiveElement table 742 can include:
a) passive_element_id;
b) passive_element_name;
c) activity_status;
d) element_location;
e) element_type;
f) default_weighting_coefficient;
g) element_attribute_id; and
h) date_time.

An example of an ElementAttribute table 743 as shown in FIG. 7J stores information relating to element attribute types and values and the relationship of element attribute to elements. Properties (i.e. columns) of the ElementAttribute table 743 can include:
a) element_attribute_id;
b) element_attribute_type;
c) element_attribute_value;
d) element_id; and
e) date_time.

An example of a StateConditions table 744 as shown in FIG. 7K stores information relating to state conditions, such as, for example, default conditions, preemptive conditions, and safety conditions, as well as intersection and trafficway relationships. Properties (i.e. columns) of the StateCondtions table 744 can include:
a) state_condition_id;
b) state_condition_type;
c) signaling_pattern_id;
d) timing_pattern_id;
e) intersection_id;
f) trafficway_id; and
g) date_time.

An example of a Trafficway table 745 as shown in FIG. 7L stores information relating to trafficways. Properties (i.e. columns) of the Trafficway table 745 can include:
a) trafficaway_id;
b) trafficway_name;
c) trafficway_type;
d) trafficway_location; and
e) date_time;

An example of a SignalingPattern table 746 as shown in FIG. 7M stores information relating to signaling pattern definitions as they relate to state conditions. Properties (i.e. columns) of the SignalingPattern table 746 can include:
a) signaling_pattern_id;
b) signaling_pattern_definition; and
c) date_time.

An example of a TimingPattern table 747 as shown in FIG. 7N stores information relating to signaling pattern definitions as they relate to state conditions. Properties (i.e. columns) of the TimingPattern table 747 can include:
d) timing_pattern_id;
e) timing_pattern_definition; and
f) date_time.

An example of a PreferenceRank table 748 as shown in FIG. 7O stores information relating to signaling pattern definitions as they relate to state conditions. Properties (i.e. columns) of the PreferenceRank table 748 can include:
a) preference_rank_id;
b) tracked_vehicle_id;
c) intersection_id;
d) trafficway_id;
e) preference_rank_id; and
f) date_time.

An example of a Rules table 749 as shown in FIG. 7P stores information relating to rule definitions and their relationships to intersections and trafficways. Properties (i.e. columns) of the Rules table 749 can include:
a) rule_id;
b) rule_name;
c) rule_definition;
d) intersection_id;
e) trafficway_id; and
f) date_time.

Various additional logical databases can include, for example, a preference ranking database 430 (e.g., see FIG. 4) storing a plurality of preference rankings that act as flow controls and inputs for the decision engine, an activity logs database 428 storing activity data.

The traffic control system controls traffic flow by interrupting the normal traffic flow. This interruption can be accomplished by preempting the normal traffic signal state in providing for preference ordered flow control of mobile elements, such as haul trucks, providing notification to a tracked vehicle driver to perform an action, such as changing velocity, and the like.

In some embodiments, interruption is based, at least in part, upon data received by the tracking service 402 (e.g., see FIG. 4) when one or more tracked vehicles penetrate a boundary, are within geo-fence area, or both. Situations that can initiate the transmission of preemptive instructions include, for example:
a) Detection of one or more tracked vehicles approaching an intersection where the tracked vehicles may have different element attribute characteristics, such as different destinations, different load characteristics, and the like. Based, at least in part, upon the evaluation of rules contained in the rule preference rank database 430 by the decision engine 450, preemption may be required.
b) Detection of multiple tracked vehicles approaching the same intersection where the one or more element attributes, such as, for example, visibility, may render it safer if one tracked vehicle passes through the intersection prior to another.

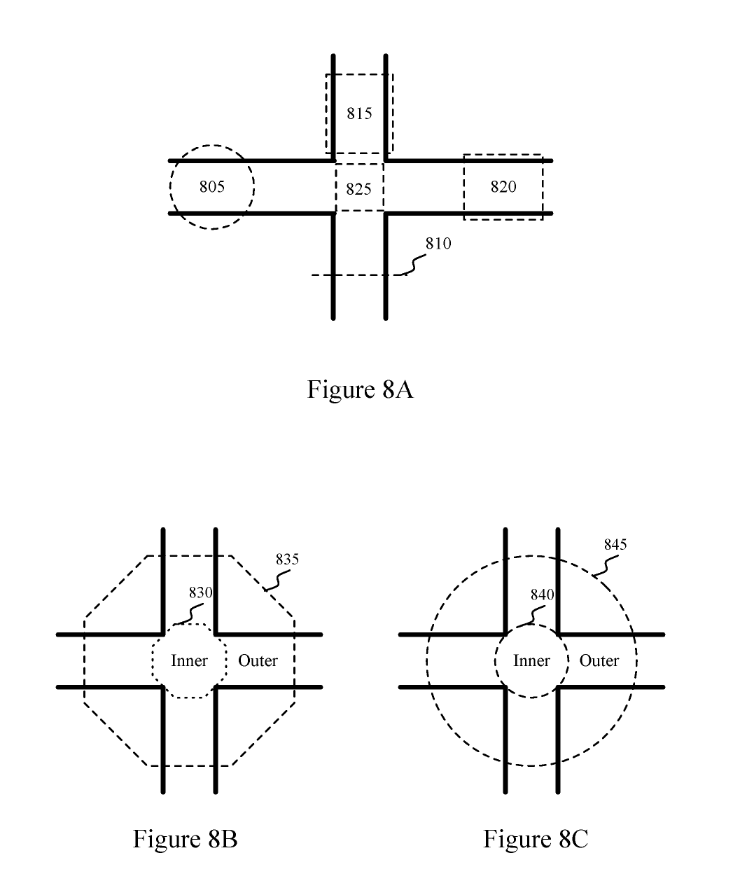

In some embodiments, geo-fences operate in one or more modes. Referring now to FIG. 8A, multiple geo-fences operate in coordinated-mode. In this example, there are five geo-fences, each covering a different area of the trafficway or intersection. Geo-fences 815, 820, are polygonal geo-fences, geo-fence 810 is a linear boundary geo-fence, and while geo-fences 805 and 810 are circular geo-fences. Geo-fences 805, 810, 815, and 820 are peripheral, or outer, geo-fences, while geo-fence 825 is the intersection, or inner, geo-fence. As tracked vehicles move along the traffic ways or through the areas defined by the geo-fences, they are tracked from one geo-fence to another. Preemptive logic is based, at least in part, on whether a tracked vehicle is located within a particular geo-fence area.

In other embodiments, geo-fences are internally organized into an “inner” and an “outer” area of a single geo-fence, and operate in a multi-level mode. Referring now to FIG. 8B and FIG. 8C, the geo-fence can include inner boundaries 830, 840 and outer boundaries 835, 845. In some instances boundaries are polygonal 835, 840, while in other instances, boundaries are circular 840, 845. Preemptive logic is based, at least in part, on the position of a tracked vehicle within the geo-fence area.

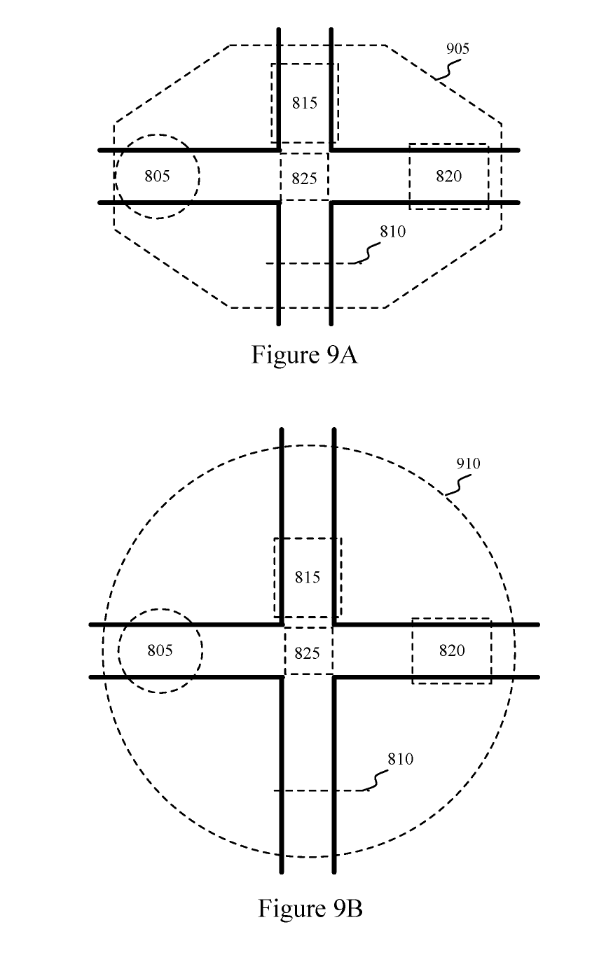

In yet other embodiments, multiple geo-fences are arranged in a combination coordinated-mode and multi-level mode. Referring now to FIG. 9A and FIG. 9B, penetration by a tracked vehicle of the outer geo-fence 905, 910 can serve as an input to preemption logic associated with the coordinated geo-fences 805, 810, 815, 820, 825. In some instances, one or more of the coordinated geo-fences 805, 810, 815, 820, 825 can be alternately defined as an inner boundary area of the geo-fence area defined by the outer boundary 905, 910.

In some instances GPS coordinates for geo-fences are established by a physical survey of the perimeter of applicable trafficways and intersections with a GPS device. Alternatively, or in addition, the geo-fence perimeter can be determined with satellite images.

A geo-fence periphery definition can be maintained in the traffic control server database. In some instances, the database includes a two-table data model represented in a relational database, xml flat file, or the like. The two-table geo-fence periphery data model can include a geo-fence table and a geo-fence vertices table. The geo-fence table records can have the following structure, which includes storing its associated intersection and its type (e.g., polygon or circle):

<Row>

<Cell><Data ss:Type=“String”>id</Data></Cell>
<Cell><Data ss:Type=“String”>intersection_id</Data></Cell>
<Cell><Data ss:Type=“String”>geo_fence_type_id</Data></Cell>
<Cell><Data ss:Type=“String”>geo_fence_geometry_id</Data></Cell>
<Cell><Data ss:Type=“String”>center_lat</Data></Cell>
<Cell><Data ss:Type=“String”>center_long</Data></Cell>
<Cell><Data ss:Type=“String”>radius</Data></Cell>
<Cell><Data ss:Type=“String”>created_at</Data></Cell>
<Cell><Data ss:Type=“String”>updated_at</Data></Cell>

</Row>

As described in this example data table, the table can include rows with multiple fields, such fields including, for example, id (unique), intersection_id, geo_fence_type_id, geo_fence_geometry_id, center_lat, center_long, radius, created_at, and updated_at.

The geo-fence vertices records can have the following structure, which includes the latitude and longitude of all the vertices for the polygon, the associated geo-fence, and the order:

<Row>

<Cell><Data ss:Type=“String”>id</Data></Cell>
<Cell><Data ss:Type=“String”>geo_fence_id</Data></Cell>
<Cell><Data ss:Type=“String”>lat</Data></Cell>
<Cell><Data ss:Type=“String”>long</Data></Cell>
<Cell><Data ss:Type=“String”>ordering</Data></Cell>

</Row>

In some embodiments, the system includes a method for determining if a point is inside a polygon or not (e.g., see the definition for “bool cGeoFencePolygon::IsInside(cGpsInfo location) along with supporting methods below). This method calculates whether the point is inside the polygon.

bool cGeoFencePolygon::IsInside( cGpsInfo location )
{

bool oddNodes = false;
int numSides = mGpsVerticies.count( );
double xLoc;
double yLoc;
double xVertexHead;
double yVertexHead;
double xVertexTail;
double yVertexTail;
xLoc = location.GetX( );
yLoc = location.GetY( );
xVertexTail = mGpsVerticies.last( ).GetX( );
yVertexTail = mGpsVerticies.last( ).GetY( );
for( QVector<cGpsInfo>::iterator itr = mGpsVerticies.begin( ); itr !=

mGpsVerticies.end( ); ++itr )

{

xVertexHead = itr−>GetX( );
yVertexHead = itr−>GetY( );
if ((yVertexHead < yLoc && yVertexTail >= yLoc ∥

yVertexTail < yLoc && yVertexHead >= yLoc ) &&
(xVertexHead <= xLoc ∥ xVertexTail <= xLoc ) )

{

oddNodes \hat{ }= ( ( xVertexHead + ( yLoc − yVertexHead ) /

( yVertexTail − yVertexHead ) * ( xVertexTail − xVertexHead ) ) <
xLoc );

}
yVertexTail = yVertexHead;
xVertexTail = xVertexHead;

}
return oddNodes;

}
void cGeoFencePolygon::SetVerticies( QVector<cGpsInfo> verticies )
{

mGpsVerticies = verticies;

}
QVector<cGpsInfo> cGeoFencePolygon::GetVerticies( void ) const
{

return mGpsVerticies;

}
cGpsInfo cGeoFencePolygon::GetCenterLocation( void ) const
{

return mCenterLocation;

}

The following is an example of header file that can support the “IsInside” method described above, as well as other methods associated with setting, retrieving, and assessing polygon definition and point inclusion.

#ifndef GeoFencePolygon_h_{——}
#define GeoFencePolygon_h_{——}
#include “IGeoFence.h” cGeoFencePolygon
#include “GpsInfo.h”
#include <QVector> (QVector is a class from the commercially-available
Qt framework)
class cGeoFencePolygon : public iGeoFence
{
public:

cGeoFencePolygon(long uniqueId, long intersectionId, QString
name, int level, QVector<cGpsInfo> verticies, cGpsInfo center);

~cGeoFencePolygon(void);
/**
* This method sets the GPS verticies
*
* \param QVector Verticies
*
* \return void
*/
void SetVerticies( QVector<cGpsInfo> verticies );
/**
* This method gets the GPS verticies
*
* \param void
*
* \return QVector Verticies
* a vector containing the gps verticies of the geo fence
*/
QVector<cGpsInfo> GetVerticies( void ) const;
/**
* Get geo fence name
*
* \param void
*
* \return QString
*/
eGeoFenceType_T GetType( void );
/**
* Determine if a GPS location is inside this geo fence
*
* \param cGpsInfo location
*
* \return bool
*/
bool IsInside( cGpsInfo location );
/**
*The method gets the unique ID of the geo fence
*
* \param void
*
* \return QString
*/
QString GetUniqueId(void) const;
/**
* This method is used to get a center location from
* a geopoint
*
* \param void
*
* \return cGpsInfo
*/
cGpsInfo GetCenterLocation( void ) const;

private:

/**
* This is used to calcualte the center location
*
* \param void
*
* \return void
*/
//void CalculateCenterLocation( void );

private:

cGpsInfo mCenterLocation;
QVector<cGpsInfo> mGpsVerticies;

};
#endif // GeoFencePolygon_h_{——}.

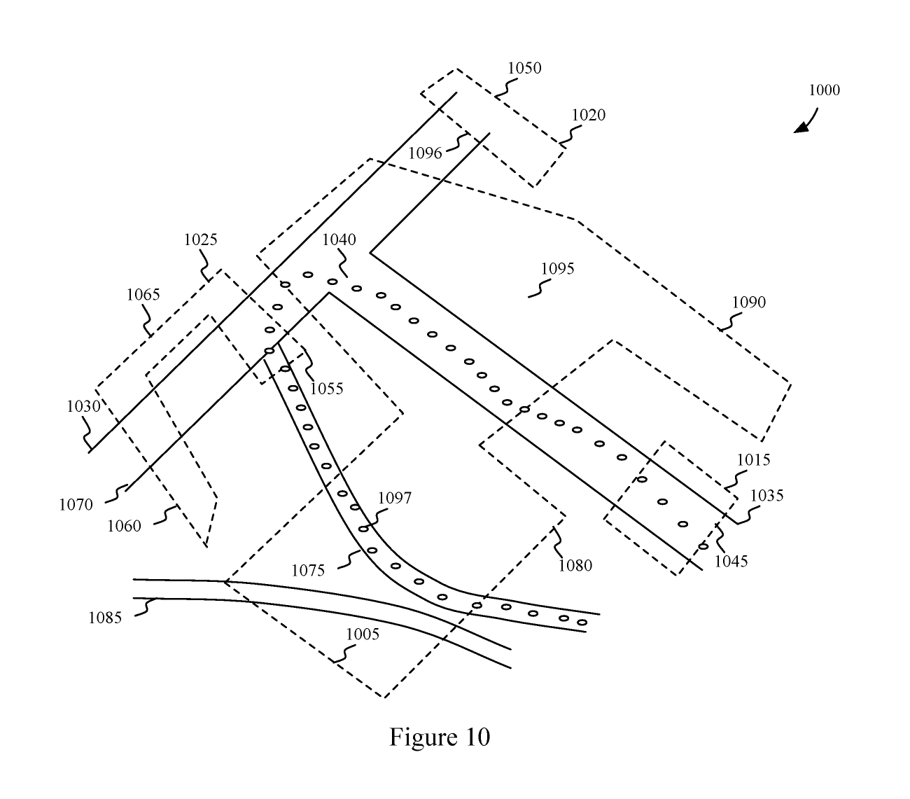

With regard now to FIG. 10, other novel, advantageous forms of geo-fences 1005, 1015, 1020, 1025 may be utilized for a given location, such as mining site, generally 1000. The mining site in this example has a primary trafficway 1030 and a secondary trafficway 1035 forming a T intersection 1040. The intersection has three outer geo-fences 1015, 1020, 1025 and one inner geo-fence 1005.

Two of the outer geo-fences 1015, 1020 are generally rectangular and designed to identify haul trucks (not shown in FIG. 10) approaching the intersection 1040 by initially penetrating the boundaries 1045, 1050 of these geo-fences 1015, 1020, respectively. The third outer geo-fence 1025 consists of two opposed generally polygonal shapes 1055, 1060 interconnected by a third generally polygonal shape 1065. The outermost polygonal shape 1060 (from the intersection 1040) detects haul trucks approaching toward the intersection 1040 from the leftmost section 1070 of the primary roadway 1030. The other two polygonal shapes 1055, 1065 detect haul trucks entering on the primary roadway 1030 (often more slowly than those traveling on the leftmost section 1070 of the primary roadway 1030) from a side dirt road 1075.

The one inner geo-fence 1005 has a somewhat inverted U-shape with: (i) the left arm 1080 of the U-shape spanning several side roads 1075, 1085 to the left of the intersection 1040; and (ii) the right arm 1090 of the U-shape spanning another area through which haul trucks travel in order to enter for the area 1095 onto the primary roadway 1030. This uniquely shaped inner geo-fence 1005 can thus track the movement of haul trucks that have penetrated the outer geo-fences 1015, 1020, 1025 but depart the vicinity of the intersection 1040 within the inner geo-fence 1005 but outside of the actual trafficways 1030, 1035 at the intersection 1040.

The location of an outer geo-fence, e.g., 1020, can be determined based, at least in part, on:

(i) the total time, measured in, for example, fractions of hours, for (a) opposing traffic to stop (e.g., often 3 to 5 seconds once a yellow light appears, plus (b) a clearing phase (e.g., red lights appearing in all directions providing time for opposing traffic to clear the intersection), plus (c) a length of time for the haul truck driver approaching the intersection to see green (e.g., often 10-20 seconds); and

(ii) multiplied by the average speed of a haul truck in miles per hour.

This calculation yields a distance for the distal outer perimeter, e.g., 1050, of the geo-fence, e.g., 1020, from the center of the intersection, e.g., 1040. Basing geo-fence location, at least in part, on truck travel time can provide improved efficiency of the overall system for particular truck travel patterns at a given location or site.

In addition, in this example, the inner outer perimeter, e.g., 1096, of the geo-fence, e.g., 1020 is set to be relatively close to the intersection, e.g., 1040. This can allow for a longer period of GPS tracking of a vehicle within the geo-fence, e.g., 1005. In this regard, the GPS reports to the traffic control system for a haul truck travelling through a trafficway, e.g., 1070 are shown as dots, e.g., 1097, along the trafficway 1070.

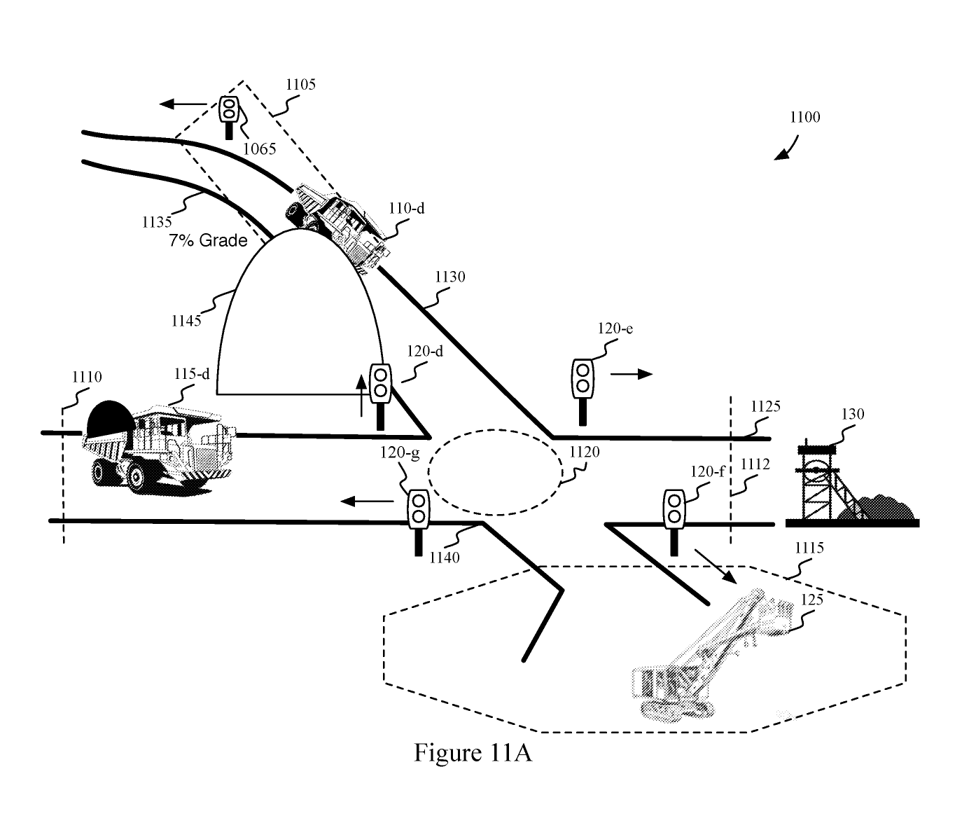

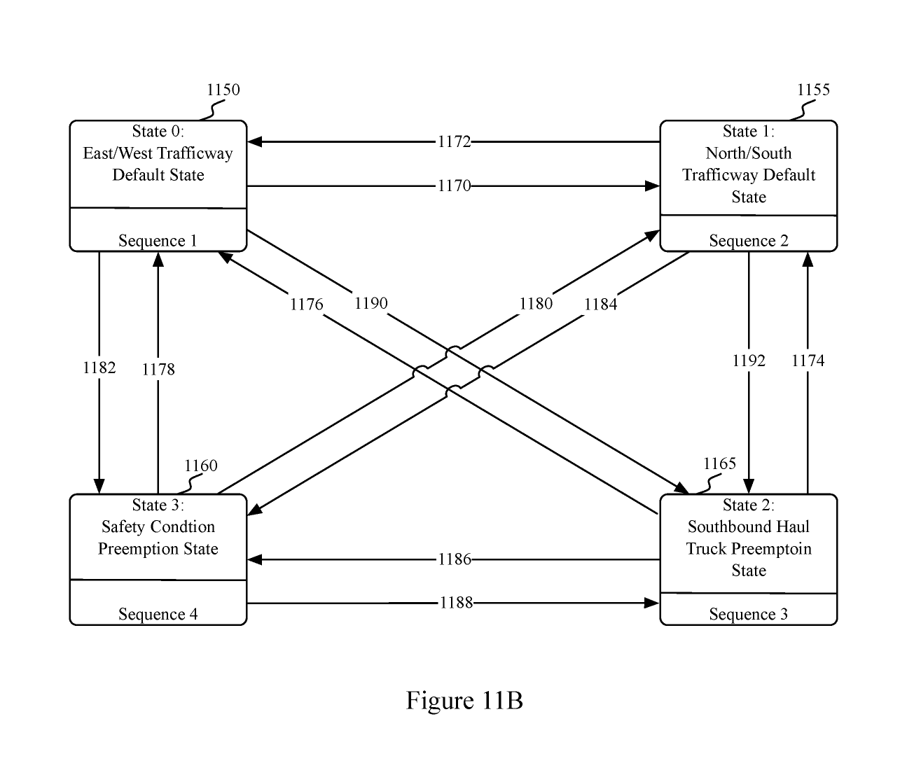

Referring to FIG. 11A, in some implementations, the traffic control server system 401 (e.g., see FIG. 4) intermittently or continuously monitors mobile elements such as loaded haul trucks 115-d, and unloaded haul trucks 110-d on at a site, such as a mining site 1100, and establishes a preference order for the haul trucks 110-d, 115-d, meaning, in some embodiments, that preemptive signaling states are initiated and ordered in a manner that recognizes the preference order of the haul trucks 110-d, 115-d. That signaling can be the result of the traffic control server system 401 having identified the haul trucks 110-d, 115-d as having penetrated a boundary and transmitted a command to the intersection traffic controller 116 (e.g., see FIG. 1) to preempt the normal signaling state with a preemption signaling state. In some instances, this causes one or more of the intersection-associated signaling lights 120-d, 120-e, 120-f, 120-g to provide a proceed signal, such as a green light, for one or more haul trucks proceeding on a common trafficway and a stop signal, such as red lights for cross-traffic on one or more intersecting trafficways. The resulting signaling state can facilitate one or more preference ordered haul trucks travelling through one or more intersection without need for stopping or slowing down due to the haul truck encountering a stop signal, such as a red light, or a slow signal, such as a flashing yellow light.

Still referring to FIG. 11A, an example intersection includes two intersecting traffic ways; a primary trafficway 1125 and a secondary trafficway 1130. The traffic service receives data, such as telemetry data, transmitted from the communication hardware 437 (e.g., see FIG. 4) installed on the haul trucks 110-d, 115-d, and the detection engine 448 continuously monitors the telemetry data, determining if a haul truck 110-d, 115-d has penetrated a boundary or is located within a geo-fence or among coordinated geo-fences. Events at the intersection 1140 and associated trafficways 1125, 1130 are detected by a group of coordinated geo-fences, including:
a) an outer polygonal geo-fence 1105 located on a northern portion of the secondary trafficway 1130 at the apex of hill 1135 with a 7% grade;
b) an outer polygonal geo-fence 1115 located on a southern portion of the secondary trafficway 1130 inclusive of a mining shovel location;
c) an outer boundary 1110 located on a western portion of the primary trafficway 1125; and
d) an outer boundary 1112 located on an eastern portion of the primary trafficway 1125 proximal to a processing station 130.
   Given the limited leftward visibility of the haul truck operators, the intersection-associated signaling lights 120-d, 120-e, 120-f, 120-g are each positioned on the right side of the trafficway relative to the view of the haul truck operator. A large slag pile 1145 is positioned on the western side of the northern portion of the secondary trafficway 1130 proximal to the lower portion of the hill 1135 and the intersection 1140. The slag pile 1145 limits the haul truck operator's westward visibility when approaching the intersection 1140.

In this example, the loaded haul truck 115-d penetrates the western outer boundary of the primary trafficway 1125. The ingress event is detected by the detection engine 448 (e.g., see FIG. 4) and if not already determined, a preference rank is determined and assigned by the preference rank engine 446 based on summing element attribute preference values associated with the haul truck 115-d along with associated passive element attributes, service element attributes, or both. In this example, this can include, but is not limited to, the load state of the haul truck 115-d, the distance of the haul truck 115-d from the intersection 1140, and the status of the processing station.

A second unloaded haul truck 110-d penetrates the northern outer polygonal geo-fence 1105 on secondary trafficway. The ingress event is detected by the detection engine 448 (e.g., see FIG. 4) and if not already determined, the preference rank is determined and assigned by the preference rank engine 446. In this example, at the time of the ingress event, the preference rank for the unloaded haul truck 110-d is determined to be higher than any other tracked vehicle, including the loaded haul truck 115-d on the primary traffic way. This can, for example, be due, at least in part, to a high weighting associated with the preference rank attribute values associated with one or more from the group of the destination, the presence of a waiting shovel 125 at the destination, the steep grade that may make stopping or slowing difficult, the visibility issues related to the slag pile, and the like.

The rules associated with this intersection and trafficway are evaluated to determine if necessary and sufficient rule conditions are met with regard to the attributes associated with the high preference-ranked, unloaded haul truck 110-d. Upon determining that, for example, there is an applicable rule where all rule conditions are met, preemptive traffic signaling instruction are sent to one or more of the intersection associated traffic signaling lights 120-d, 120-e, 120-f, 120-g, interrupting the normal signal patterning with a preemptive pattern and timing preferring passage of the unloaded haul truck 110-d. In some instances, depending on these or other factors, the primary and secondary trafficway designations can be exchanged such that the trafficway on which the unloaded haul truck 110-d is travelling becomes the primary trafficway.

The preemption state created by application of the preemptive traffic signaling instructions can be maintained until there is an egress event associated with the unloaded haul truck 110-d penetrating the boundary of the inner geo-fence 1120. In certain instances, the visibility issue created by the presence of the slag pile 1145 creates a pre-defined safety condition such that even if the loaded haul truck 115-d is determined to have a higher preference rank, the passage of the unloaded haul truck will be preferred based on the safety condition evaluation superseding rule evaluations and resulting preemptive traffic signaling instructions transmissions.

In some embodiments, a variety of distinct signaling states, along with rules that direct the sending of traffic signaling instructions to obtain such states, can be involved in managing the traffic flow through this intersection 1140. These states can include signaling processes such as, for example:
a) displaying solid-on red beacons to signal a vehicle to stop at the intersection and wait for the signal that the intersection is clear;
b) displaying solid-on green beacons to signal a vehicle that it has the right of way (cross traffic is stopped) and it does not need to stop;
c) displaying flashing red beacons to signify a “stop sign” at an intersection; the vehicles subject to this display will stop and then proceed when safe;
d) display flashing yellow beacons as an advanced warning to the intersection when appropriate, depending on, for example, vehicle speeds and intersection visibility, to signify there is a red light and the vehicle will stop ahead; and
e) when a beacon changes from flashing red or solid-on red to green, providing a period where all four directions of the intersection are stopped before the red beacon is switched to green.

Referring now to FIG. 11B, an example of such states include, but is not limited to, a default state for the primary trafficway 1150, a default state for the secondary trafficway 1155 for the situation where the secondary trafficway 1130 is designated as primary, the safety condition preemption state 1160 associated with the visibility limitation described, and the preemption state 1165 associated with southbound unloaded haul trucks travelling on the secondary trafficway 1130 (e.g., see FIG. 11A).

In some instances, such as in this example, it is possible to transition from any one state to any other state. For example, referring also to the example described in FIG. 11A, the default traffic signaling state 1150 could be interrupted and changed to a second state 1155 associated with changing the primary/secondary trafficway designations 1170. Similarly, the reverse can occur where the primary/secondary trafficway designations are returned to the initial configuration 1172. Upon a pre-defined egress event, such as exiting an intersection, a preemptive traffic signaling state 1165 can be interrupted and returned to the current default state 1174, 1176. Similarly, upon detection by the detection engine 448 (e.g., see FIG. 4) that a safety condition no longer exists, the safety condition traffic signaling preemption state 1160 can be interrupted and returned to the current default state 1178, 1180.

In certain instances, upon detection of a safety condition, one or more default or preemptive states 1150, 1155, 1165 can be interrupted and superseded by a safety condition preemption state initiated by detection of the presence of safety condition and the application of a rule associated with the safety condition 1182, 1184, 1186. In some instances, when a safety condition is no longer present, at least one tracked vehicle is present such that the preference ranking and rule selection process occurs, resulting in transmission of a preemptive traffic signaling instructions, obtaining a preemptive traffic signaling state 1188 associated with the a preference ranked vehicle. A preemptive traffic signaling state can also be obtained from a non-safety condition state, such as a default state 1150, 1155, where a preference ranked vehicle is detected and the conditions of an applicable rule are met 1190, 1192.

In another example, the tracked vehicle traffic data may include schedule data indicating expected intersection traffic for the tracked vehicles. The schedule data may indicate, for example, how many tracked vehicles that may be expected to cross the intersection from each intersecting trafficways, such as over a determined period of time. The tracked vehicle traffic data may include local site data, such as, in the case of a mining site, mining site location data indicating a mine location, mining site material quality data indicating a destination for material mined from the mine, and the like. The mining site data may also indicate a need for one or more types of vehicles at a mine based on, for example, shovel status at the mine indicating that shovels are sitting idle. As such, the traffic control system can change the one or more traffic signaling states to minimize stopping of tracked vehicles of the type needed to and from the mine.

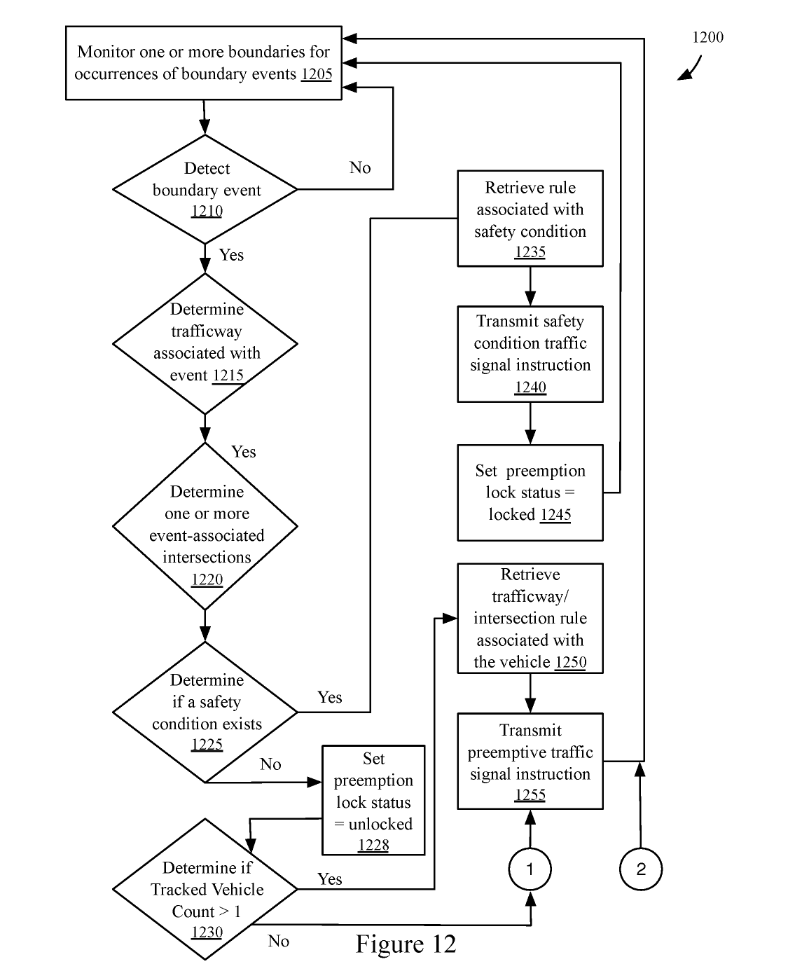

Turning to FIG. 12, a method 1200 for monitoring and managing traffic flow is shown in accordance with various embodiments. The method 1200 may be carried out by a traffic control system and may, for example, be performed by a traffic control server system of FIG. 1, 2, 4, 5, or 6 using any combination of the devices described for these figures. Initially, at block 1205, the traffic control server system, in communication with one or more devices providing location information, monitors one or more boundaries for the occurrence of boundary events. Boundary events can include, for example, boundary penetration, ingress into a geo-fence, egress from a geo-fence, traversal between coordinated geo-fences, and the like. Upon detection of a boundary event 1210, a determination can be made identifying the associated trafficway 1215 and intersection 1220 for use in determining applicable safety conditions and rule retrieval.

In some instances, prior to implementing efficiency-directed preemption strategies, the traffic control server determines if a safety condition is present 1225 applicable to one or more of the tracked vehicles. If a safety condition is detected, an associated rule, if assigned, is retrieved 1235 and the resulting safety condition traffic signal instruction is transmitted 1240 to, for example, a traffic controller. In some implementations, a preemption lock status is set to locked 1245, thus preventing subsequent preemption instruction from being implemented until the status is set to unlocked. In the case where a safety condition is not detected 1225, the preemption lock status is set to unlocked 1228, allowing for preemptive traffic signal instructions to be implemented.

If there is only one tracked vehicle approaching the intersection, the trafficway and intersection identifying information determined previously 1215, 1220 the preemptive traffic control signaling rule associated with trafficway/intersection and with the vehicle is retrieved 1250. Once retrieved, the rule is then interpreted and the resulting preemptive traffic control signaling instruction is transmitted to one or more traffic control devices 1255.

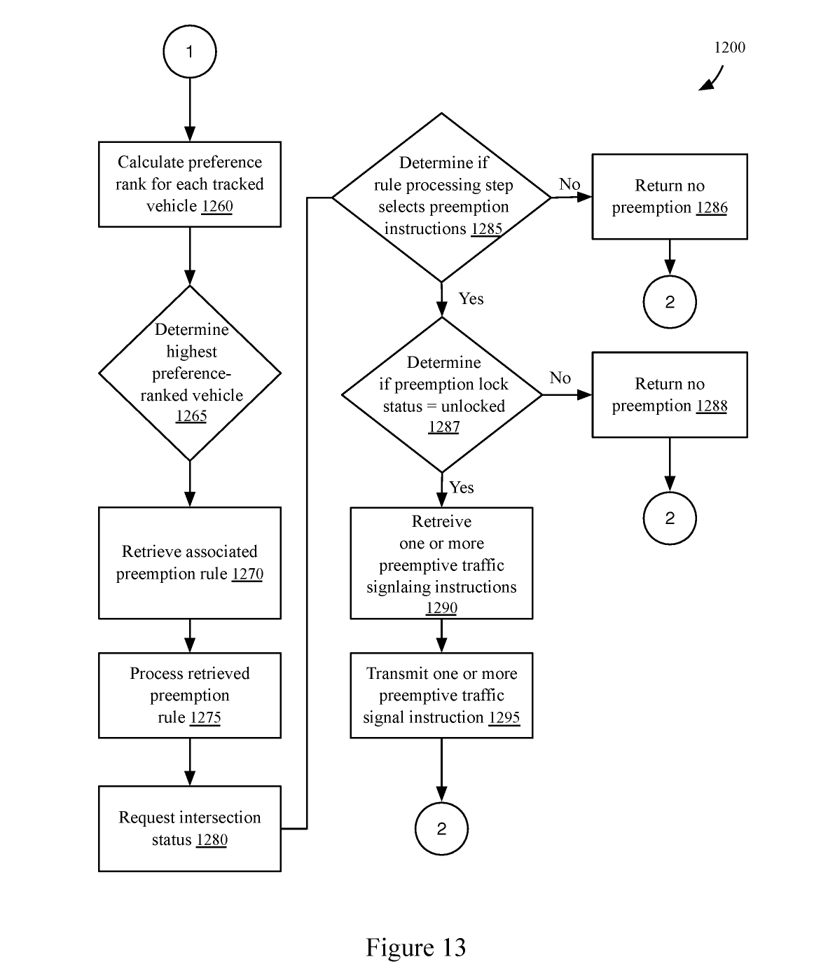

Alternatively, referring now to FIG. 13, if more than one tracked vehicle approaching the intersection, then a preference is calculated for each vehicle 1260, and a determination is made which vehicle is assigned the highest preference rank value 1265. The preemptive traffic signal rule associated with the trafficway and intersection, applicable to the vehicle, is retrieved 1270, and the rule is processed 1275 to determine if the conditions of the rule are met.

An intersection status request is sent 1280 to receive the current preemption lock status for the intersection, and a determination is made whether associated preemptive traffic signaling instructions are selected as part of the rule consequent 1285. If there are no resulting associated preemptive traffic signaling instructions, or if the intersection preemption lock status is set to locked, no preemption direction is returned or executed. Alternatively, if both of the aforementioned conditions are met, then one or more preemptive traffic signal instructions associated with the trafficway and intersection, applicable to the highest preference-ranked vehicle, are retrieved 1290 and transmitted to one or more traffic control devices 1295.

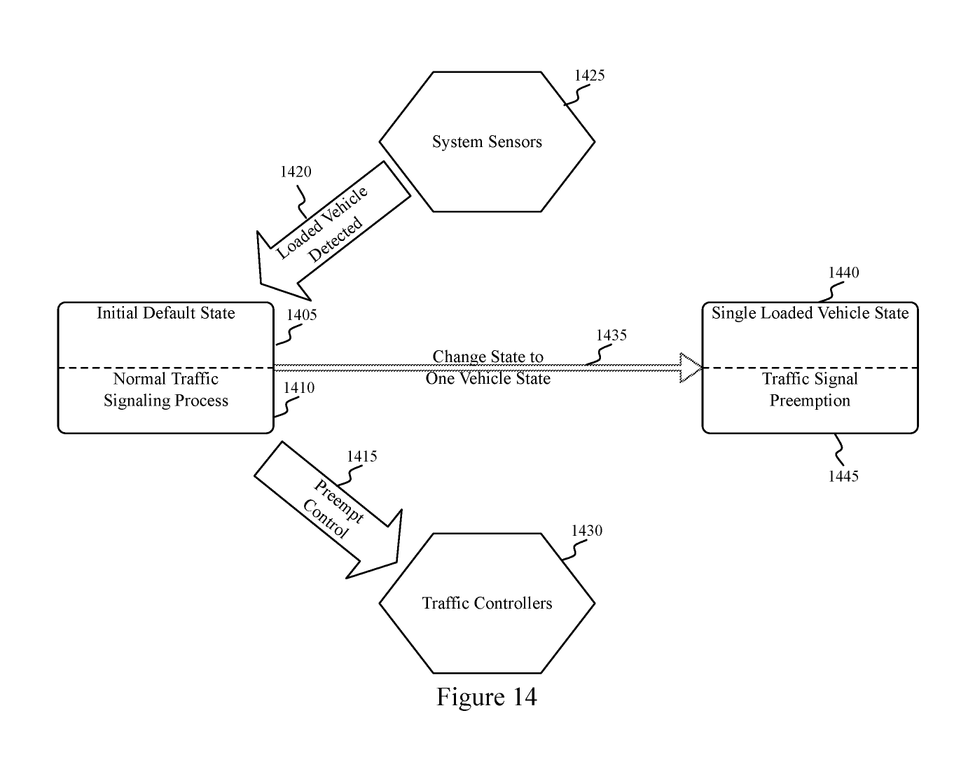

In some embodiments, the preemption logic and state transition logic is rule-based. The determination of which tracked vehicle receives access to an intersection is determined by these rules that can be stored in the rule and preference rank database. In some embodiments, rules can be expressed and implemented in terms of:
a) an antecedent state of one or more element attributes prior to the detection of an event;
b) the detection of a new event;
c) one or more consequent actions executed in response to detection of one or more events; and
d) achieving a consequent state in response to the execution of one or more actions.
   For example, referring now to FIG. 14, a rule is implemented according to the following:
a) current state=tracked vehicles in intersection-associated geo-fence=0;
b) current state=intersection-associated traffic signaling state=default;
c) event=ingress of loaded vehicle to intersection-associated geo-fence;
d) action=change intersection-associated traffic signaling state=preemption signaling state; and
e) resulting state=tracked loaded vehicle in intersection-associated geo-fence=1.

Initially, the traffic signal operates a default state 1405, which, in this example, is a normal traffic signaling process. System sensors 1425, such as GPS sensors in combination with a detection engine 448 (e.g., see FIG. 4), detect the ingress of a loaded vehicle 1420 when it penetrates a boundary of the geo-fence. Preemption control is initiated 1415 at one or more traffic controllers 1430, and the resulting traffic signal state is changed 1435 to a preemption traffic signal state 1445 associated with the detected presence of a loaded vehicle 1440.

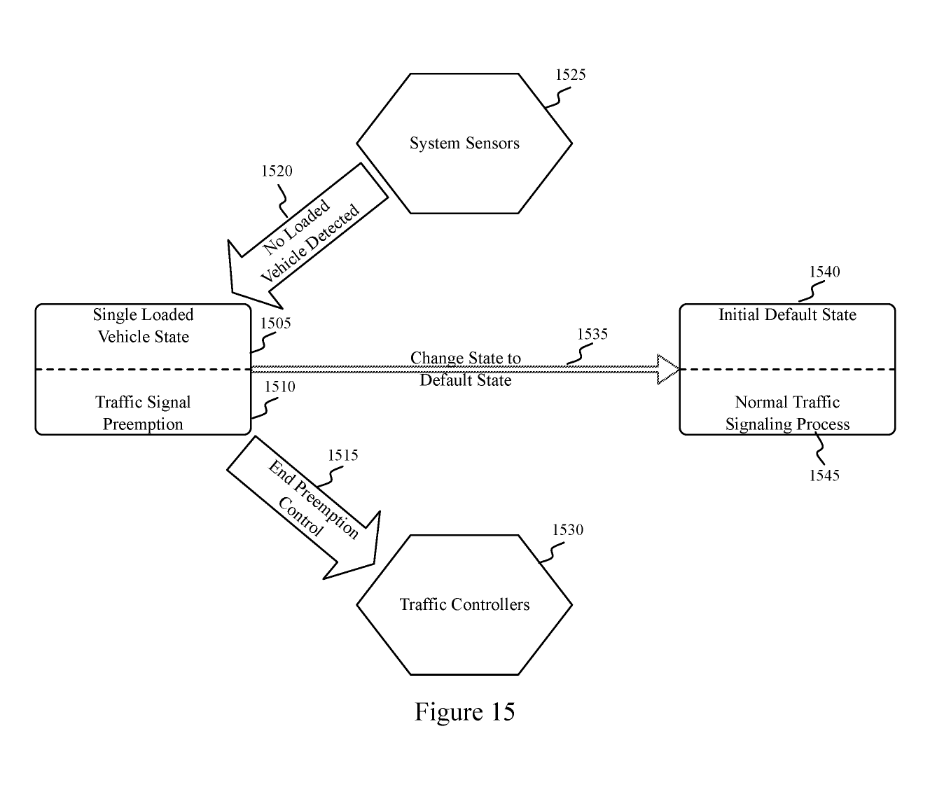

Referring now to FIG. 15, another rule can determine, in part, what happens when the tracked loaded vehicle leaves the intersection where no other vehicle is detected. The rule can be implemented according to the following:
a) current state=tracked loaded vehicles in intersection-associated geo-fence=1;
b) current state=intersection-associated traffic signaling state=preemption signaling state;
c) event=egress of loaded vehicle from intersection-associated geo-fence;
d) action=change intersection-associated traffic signaling state=default; and
e) resulting state=tracked loaded vehicle in intersection-associated geofence=0.

Initially, the traffic signal operates a preemption traffic signal state 1510, which, in this example, is a single loaded vehicle state 1505. System sensors 1525, such as GPS sensors in combination with a detection engine 448 (e.g., see FIG. 4), detect the egress of a loaded vehicle 1520 when it penetrates a boundary of the geo-fence. Preemption control is terminated 1515 at one or more traffic controllers 1530, and the resulting traffic signal state is changed 1535 to a default traffic signal state 1545 associated with the absence of a loaded vehicle 1540.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures may be implemented to achieve the same functionality.

On reading this disclosure, those of skill in the art will recognize that many of the components discussed as separate units may be combined into one unit and an individual unit may be split into several different units. Further, the various functions could be contained in one computer or spread over several networked computers and/or devices. The identified components may be upgraded and replaced as associated technology improves, advances are made in computing technology, or based on a developer's skills or preferences.

The process parameters, functions, system features, and sequence of steps described and/or illustrated herein are given by way of example only and may be varied and mixed and matched as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, the functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems, their components, and methods and various embodiments with various modifications as may be suited to the particular use contemplated.

Unless otherwise noted, the terms “a” or “an,” as used in the specification and claims, are to be construed as meaning “at least one of” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. An automated traffic control process comprising:
automatically remotely monitoring a preference vehicle location of a preference vehicle;
automatically determining if the preference vehicle location is at or past a predetermined approach location with respect to a remote intersection, and upon automatically determining that the preference vehicle is at or past the predetermined approach location, automatically:
transmitting a traffic preemption instruction to a remote intersection traffic signaling controller associated with the remote intersection; and
determining if the preference vehicle is at or past a second location with respect to the remote intersection, and upon determining that the preference vehicle is at or past the second location, transmitting a second signal to the remote intersection traffic signaling controller,
whereby the preference vehicle receives right of way from the remote intersection traffic signaling controller.

2. The automated traffic control process of claim 1 also including: locking a remote intersection traffic signal state in a signal locking period between the predetermined location determining step and the second location determining step.

3. The automated traffic control process of claim 1 wherein the second location is at or past a predetermined departure location with respect to the remote intersection.

4. The automated traffic control process of claim 2 wherein the second location is at or past a predetermined departure location with respect to the remote intersection.

5. The automated traffic control process of claim 1 wherein a central traffic control system provides the automatically remotely monitoring step, the predetermined location determining step, and the preempting instruction transmitting step.

6. The automated traffic control process of claim 4 wherein central traffic control system provides the automatically remotely monitoring step, the predetermined location determining step, and the preempting instruction transmitting step.

7. The automated traffic control process of claim 1 wherein the automatically monitoring step includes automatically remotely monitoring a plurality of preference vehicle locations.

8. The automated traffic control process of claim 6 wherein the automatically monitoring step includes automatically remotely monitoring a plurality of preference vehicle locations.

9. An automated traffic control system comprising;
a computing system having non-transitory memory containing one or more traffic control software components for:
automatically remotely monitoring a preference vehicle location of a preference vehicle;
automatically determining if the preference vehicle location is at or past a predetermined approach location with respect to a remote intersection, and upon automatically determining that the preference vehicle is at or past the predetermined approach location, automatically:
transmitting a traffic signal preempting instruction through to a remote intersection traffic signaling controller associated with the remote intersection; and
determining if the preference vehicle is at or past a second location with respect to the remote intersection, and upon determining that the preference vehicle is at or past the second location, transmitting a second signal to the remote intersection traffic signaling controller.

10. The automated traffic control system of claim 9 wherein the one or more software control components are also for locking a remote intersection traffic signal state in a signal locking period after transmission of the traffic signal preempting instruction.

11. The automated traffic control system of claim 9 wherein the second location is at or past a predetermined departure location with respect to the remote intersection.

12. The automated traffic control system of claim 10 wherein the second location is at or past a predetermined departure location with respect to the remote intersection.

13. The automated traffic control system of claim 9 wherein a central traffic control system provides the automatically remotely monitoring step, the predetermined location determining step, and the preempting instruction transmitting step.

14. The automated traffic control system of claim 9 wherein automatically monitoring includes automatically remotely monitoring a plurality of preference vehicle locations.

15. The automated traffic control system of claim 13 wherein automatically monitoring includes automatically remotely monitoring a plurality of preference vehicle locations.

16. An automated traffic control system comprising in combination:
a plurality of portable vehicle locator transmitters in communication with a communications network;
an traffic intersection signaling controller in communication with the communications network;
a central computing server system in communication with the communications network and having one or more server system applications providing:
detection of penetration of a boundary spaced from a traffic intersection by a first portable vehicle locator transmitter among the plurality of portable vehicle locator transmitters;
identification of a first preference rank associated with a first vehicle having a first portable vehicle location transmitter;
based on the first preference rank associated with the first vehicle, issuing a right of way traffic control signal toward the traffic intersection signaling controller.

17. The automated traffic control system of claim 16 wherein the one or more software applications also provide determination of whether a safety condition exists and, if so, alters issuance of the or another right of way traffic control signal.

18. The automated traffic control system of claim 16 wherein the one or more software applications also provide assessment of a whether the traffic intersection signaling controller should be operating according to one among differing hierarchical condition categories.

19. The automated traffic control system of claim 16 wherein the one or more software applications also provide issuance of traffic intersection signal locking instruction in association with issuing a right of way traffic control signal toward the traffic intersection signaling controller.

20. The automated traffic control system of claim 16 wherein (i) the plurality of portable vehicle locator transmitters include a second portable vehicle locator transmitter and (ii) the one or more server system applications further provide:
detection of penetration of the or another boundary spaced from the or another traffic intersection by the second portable vehicle locator transmitter;
identification of a second preference rank associated with a second vehicle having the second portable vehicle location transmitter;
determining whether to issue the or another right of way traffic control signal based on second preference rank associated with the second vehicle.
